(19) United States
(12) Patent Application Publication
(10) Pub. No.: US 2021/0110522 A1
(43) Pub. Date: Apr. 15, 2021

(54) IMAGE PROCESSING METHOD AND APPARATUS, AND STORAGE MEDIUM

(71) Applicant: SHENZHEN SENSETIME TECHNOLOGY CO., LTD., Shenzhen (CN)

(72) Inventors: Sijie REN, Shenzhen (CN); Yan CHEN, Shenzhen (CN); Xuanye CHENG, Shenzhen (CN); Wenxiu SUN, Shenzhen (CN)

(21) Appl. No.: 17/129,189

(22) Filed: Dec. 21, 2020

Related U.S. Application Data
(63) Continuation of application No. PCT/CN2019/087637, filed on May 20, 2019.

(30) Foreign Application Priority Data
Dec. 14, 2018 (CN) 201811536144.3

(51) Int. Cl. G06T 5/50; G06T 7/521; G06T 7/55; G06T 3/40; G06T 5/00; G01S 17/894; G01B 11/22

(52) U.S. Cl. CPC G06T 5/50; G06T 7/521; G06T 7/55; G06T 3/40; G06T 2207/20081; G01S 17/894; G01B 11/22; G06T 2207/10028; G06T 2207/20084; G06T 5/002

(57) ABSTRACT

The present disclosure relates to image processing method and apparatus, and storage medium. The method includes: obtaining multiple original images which are collected by a Time of Flight (TOF) sensor in the same exposure process and have a signal-noise rate lower than a first numerical value, where phase parameter values corresponding to same pixel points in the multiple original images are different; and performing optimization processing on the multiple original images by means of a neural network to obtain depth maps corresponding to the multiple original images, where the processing includes at least one convolution processing and at least one nonlinear function mapping processing. Embodiments of the present disclosure may effectively recover high-quality depth information from the original images.

The present application is a continuation of and claims priority under 35 U.S.C. 120 to PCT Application. No. PCT/CN2019/087637, filed on May 20, 2019, which claims priority to Chinese Patent Application No. 201811536144.3, filed with the Chinese Patent Office on Dec. 14, 2018 and entitled “IMAGE INFORMATION OPTIMIZATION METHOD AND APPARATUS, ELECTRONIC DEVICE, AND STORAGE MEDIUM”. All the above-referenced priority documents are incorporated herein by reference in their entirety.

### TECHNICAL FIELD

The present disclosure relates to the field of image processing, and in particular, to image processing methods and apparatuses, electronic devices, and storage media.

### BACKGROUND

Depth image acquisition or image optimization has important application value in many fields. For example, in the fields of resource exploration, three-dimensional reconstruction, robot navigation, etc., obstacle detection, automatic driving, living body detection, etc. all rely on high-precision three-dimensional data of scenes. In the related technologies, it is difficult to obtain accurate depth information of images under the condition of low signal-noise rate, which is reflected in black holes lacking of depth information in the obtained depth image.

### SUMMARY

Embodiments of the present disclosure provide technical solutions for image optimization.

According to a first aspect of the present disclosure, provided is an image processing method, including: obtaining multiple original images which are collected by a Time of Flight (TOF) sensor in the same exposure process and have a signal-noise rate lower than a first numerical value, where phase parameter values corresponding to same pixel points in the multiple original images are different; and performing optimization processing on the multiple original images by means of a neural network to obtain depth maps corresponding to the multiple original images, where the processing includes at least one convolution processing and at least one nonlinear function mapping processing.

In some possible implementations, the performing optimization processing on the multiple original images by means of a neural network to obtain depth maps corresponding to the multiple original images includes: performing optimization processing on the multiple original images by means of the neural network, and outputting multiple optimized images of the multiple original images, where the signal-noise rate of each optimized image is higher than that of each original image; and performing post-processing on the multiple optimized images to obtain depth maps corresponding to the multiple original images.

In some possible implementations, the performing optimization processing on the multiple original images by means of a neural network to obtain depth maps corresponding to the multiple original images includes: performing optimization processing on the multiple original images by means of the neural network, and outputting the depth maps corresponding to the multiple original images.

In some possible implementations, the performing optimization processing on the multiple original images by means of a neural network to obtain depth maps corresponding to the multiple original images includes: inputting the multiple original images into the neural network for optimization processing, to obtain the depth maps corresponding to the multiple original images.

In some possible implementations, the method further includes: performing preprocessing on the multiple original images to obtain the multiple preprocessed original images, the preprocessing including at least one of the following operations: image calibration, image correction, linear processing between any two original images, or nonlinear processing between any two original images; and the performing optimization processing on the multiple original images by means of the neural network to obtain depth maps corresponding to the multiple original images includes: inputting the multiple preprocessed original images into the neural network for optimization processing, to obtain the depth maps corresponding to the multiple original images.

In some possible implementations, the optimization processing performed by the neural network includes Q groups of optimization procedures which are performed sequentially, and each group of optimization procedures includes at least one convolution processing and/or at least one nonlinear mapping processing; where the performing optimization processing on the multiple original images by means of the neural network includes: using the multiple original images as input information of a first group of optimization procedures, and obtaining a feature optimal matrix for the first group of optimization procedures after the processing of the first group of optimization procedures; using a feature optimal matrix output in the n-th group of optimization procedures as input information of the (n+1)-th group of optimization procedures for optimization processing, or using feature optimal matrices output in the first n groups of optimization procedures as input information of the (n+1)-th group of optimization procedures for optimization processing, where n is an integer greater than 1 and less than Q; and obtaining an output result based on a feature optimal matrix obtained after the processing of the Q-th group of optimization procedures.

In some possible implementations, the Q groups of optimization procedures include down-sampling processing, residual processing, and up-sampling processing which are performed sequentially, and the performing optimization processing on the multiple original images by means of the neural network includes: performing the down-sampling processing on the multiple original images to obtain first feature matrix fusing feature information of the multiple original images; performing the residual processing on the first feature matrix to obtain a second feature matrix; and performing the up-sampling processing on the second feature matrix to obtain a feature optimal matrix, where the output result of the neural network is obtained based on the feature optimal matrix.

In some possible implementations, the performing the up-sampling processing on the second feature matrix to obtain a feature optimal matrix includes: using a feature matrix obtained in the down-sampling processing procedure to perform the up-sampling processing on the second feature matrix to obtain the feature optimal matrix.

In some possible implementations, the neural network is obtained by training a train set, where each of multiple training samples included in the train set includes multiple first sample images, multiple second sample images corresponding to the multiple first sample images, and depth maps corresponding to the multiple second sample images, where the second sample image and the corresponding first sample image are images for the same object, and the signal-noise rate of the second sample image is higher than that of the first sample image; where the neural network is a generative network in a generative adversarial network obtained by training; a network loss value of the neural network is a weighted sum of a first network loss and a second network loss, where the first network loss is obtained based on differences between multiple predicted optimization images obtained by processing the multiple first sample images included in the training sample by means of the neural network and the multiple second sample images included in the training sample, and the second network loss is obtained based on differences between predicted depth maps obtained by post-processing the multiple predicted optimization images and depth maps included in the training sample.

According to a second aspect of the present disclosure, provided is an image processing method, including: obtaining multiple original images which are collected by a TOF sensor in the same exposure process and have a signal-noise rate lower than a first numerical value, where phase parameter values corresponding to same pixel points in the multiple original images are different; and performing optimization processing on the multiple original images by means of a neural network to obtain depth maps corresponding to the multiple original images, where the neural network is obtained by training a train set, each of multiple training samples included in the train set includes multiple first sample images, multiple second sample images corresponding to the multiple first sample images, and depth maps corresponding to the multiple second sample images, where the second sample image and the corresponding first sample image are images for the same object, and the signal-noise rate of the second sample image is higher than that of the first sample image.

In some possible implementations, the performing optimization processing on the multiple original images by means of a neural network to obtain depth maps corresponding to the multiple original images includes: performing optimization processing on the multiple original images by means of the neural network, and outputting multiple optimized images of the multiple original images, where the signal-noise rate of each optimized image is higher than that of each original image; and performing post-processing on the multiple optimized images to obtain depth maps corresponding to the multiple original images.

In some possible implementations, the performing optimization processing on the multiple original images by means of a neural network to obtain depth maps corresponding to the multiple original images includes: performing optimization processing on the multiple original images by means of the neural network, and outputting the depth maps corresponding to the multiple original images.

In some possible implementations, the performing optimization processing on the multiple original images by means of a neural network to obtain depth maps corresponding to the multiple original images includes: inputting the multiple original images into the neural network for optimization processing, to obtain the depth maps corresponding to the multiple original images.

In some possible implementations, the method further includes: performing preprocessing on the multiple original images to obtain the multiple preprocessed original images, the preprocessing including at least one of the following operations: image calibration, image correction, linear processing between any two original images, or nonlinear processing between any two original images; and the performing optimization processing on the multiple original images by means of the neural network to obtain depth maps corresponding to the multiple original images includes: inputting the multiple preprocessed original images into the neural network for optimization processing, to obtain the depth maps corresponding to the multiple original images.

In some possible implementations, the optimization processing performed by the neural network includes Q groups of optimization procedures which are performed sequentially, and each group of optimization procedures includes at least one convolution processing and/or at least one nonlinear mapping processing; where the performing optimization processing on the multiple original images by means of the neural network includes: using the multiple original images as input information of a first group of optimization procedures, and obtaining a feature optimal matrix for the first group of optimization procedures after the processing of the first group of optimization procedures; using a feature optimal matrix output in the n-th group of optimization procedures as input information of the (n+1)-th group of optimization procedures for optimization processing, or using feature optimal matrices output in the first n groups of optimization procedures as input information of the (n+1)-th group of optimization procedures for optimization processing, where n is an integer greater than 1 and less than Q; and obtaining an output result based on a feature optimal matrix obtained after the processing of the Q-th group of optimization procedures.

In some possible implementations, the Q groups of optimization procedures include down-sampling processing, residual processing, and up-sampling processing which are performed sequentially, and the performing optimization processing on the multiple original images by means of the neural network includes: performing the down-sampling processing on the multiple original images to obtain first feature matrix fusing feature information of the multiple original images; performing the residual processing on the first feature matrix to obtain a second feature matrix; and performing the up-sampling processing on the second feature matrix to obtain a feature optimal matrix, where the output result of the neural network is obtained based on the feature optimal matrix.

In some possible implementations, the performing the up-sampling processing on the second feature matrix to obtain a feature optimal matrix includes: using a feature matrix obtained in the down-sampling processing procedure to perform the up-sampling processing on the second feature matrix to obtain the feature optimal matrix.

In some possible implementations, the neural network is a generative network in a generative adversarial network obtained by training; a network loss value of the neural network is a weighted sum of a first network loss and a second network loss, where the first network loss is obtained based on differences between multiple predicted optimization images obtained by processing the multiple first sample images included in the training sample by means of the neural network and the multiple second sample images included in the training sample, and the second network loss is obtained based on differences between predicted depth maps obtained by post-processing the multiple predicted optimization images and depth maps included in the training sample.

According to a third aspect of the present disclosure, provided is an image processing apparatus, including: an obtaining module, configured to obtain multiple original images which are collected by a TOF sensor in the same exposure process and have a signal-noise rate lower than a first numerical value, where phase parameter values corresponding to same pixel points in the multiple original images are different; and an optimizing module, configured to perform optimization processing on the multiple original images by means of a neural network to obtain depth maps corresponding to the multiple original images, where the processing includes at least one convolution processing and at least one nonlinear function mapping processing.

According to a fourth aspect of the present disclosure, provided is an image processing apparatus, including: an obtaining module, configured to obtain multiple original images which are collected by a TOF sensor in the same exposure process and have a signal-noise rate lower than a first numerical value, where phase parameter values corresponding to same pixel points in the multiple original images are different; and an optimizing module, configured to perform optimization processing on the multiple original images by means of a neural network to obtain depth maps corresponding to the multiple original images, where the neural network is obtained by training a train set, each of multiple training samples included in the train set includes multiple first sample images, multiple second sample images corresponding to the multiple first sample images, and depth maps corresponding to the multiple second sample images, where the second sample image and the corresponding first sample image are images for the same object, and the signal-noise rate of the second sample image is higher than that of the first sample image.

According to a fifth aspect of the present disclosure, provided is an electronic device, including: a processor; and a memory configured to store processor-executable instructions; where the processor is configured to execute the method according to any one of the first aspect or the second aspect.

According to a sixth aspect of the present disclosure, provided is a computer-readable storage medium, having computer program instructions stored thereon, where when the computer program instructions are executed by a processor, the method according to any one of the first aspect or the second aspect is implemented.

According to a seventh aspect of the present disclosure, provided is a computer program, including computer readable codes, where when run in an electronic device, the computer codes are executed by a processor in the electrode device to implement the method according to any one of the first aspect or the second aspect.

The embodiments of the present disclosure may be applied in the cases where the exposure rate is low, and the image signal-noise rate is low. Since signals received by a camera sensor are weak and have high noise in the foregoing cases, it is difficult to use the signals to obtain a depth value of high precision in the prior art. However, the embodiments of the present disclosure effectively recover depth information from the images of low signal-noise rate by performing optimization processing on the collected original images of low signal-noise rate, thereby solving the technical problem in the prior art that the image feature information cannot be effectively extracted. On the one hand, the embodiments of the present disclosure may solve the problem that the low signal-noise rate cannot recover depth information caused by remote measurement and high-absorptivity object measurement, and on the other hand, the problem of insufficient imaging resolution caused by the signal-noise rate requirement is solved. That is, the embodiments of the present disclosure may optimize the images of low signal-noise rate so as to recover feature information (depth information) of images.

It should be understood that the above general description and the following detailed description are merely exemplary and explanatory, and are not intended to limit the present disclosure.

### BRIEF DESCRIPTION OF THE DRAWINGS

The drawings here incorporated in the specification and constituting a part of the specification describe the embodiments of the present disclosure and are intended to explain the technical solutions of the present disclosure together with the specification.

FIG. 1 is a flowchart illustrating an image processing method according to embodiments of the present disclosure;

FIG. 2 is an exemplary flowchart illustrating optimization processing in the image processing method according to embodiments of the present disclosure;

FIG. 3 is another exemplary flowchart illustrating optimization processing in the image processing method according to embodiments of the present disclosure;

FIG. 4 is an exemplary flowchart illustrating a first group of optimization procedures in the image processing method according to embodiments of the present disclosure;

FIG. 5 is an exemplary flowchart illustrating a second group of optimization procedures in the image processing method according to embodiments of the present disclosure;

FIG. 6 is an exemplary flowchart illustrating a third group of optimization procedures in the image processing method according to embodiments of the present disclosure;

FIG. 7 is another flowchart illustrating the image processing method according to embodiments of the present disclosure;

FIG. 8 is another flowchart illustrating the image processing method according to embodiments of the present disclosure;

FIG. 9 is another flowchart illustrating the image processing method according to embodiments of the present disclosure;

FIG. 10 is a block diagram illustrating an image processing apparatus according to embodiments of the present disclosure;

FIG. 11 is another block diagram illustrating the image processing apparatus according to embodiments of the present disclosure;

FIG. 12 is a block diagram illustrating an electronic device according to embodiments of the present disclosure; and

FIG. 13 is a block diagram illustrating another electronic device according to embodiments of the present disclosure.

### DETAILED DESCRIPTION

Various exemplary embodiments, features, and aspects of the present disclosure are described below in detail with reference to the accompanying drawings. The same reference numerals in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

The term “and/or” as used herein is merely the association relationship describing the associated objects, indicating that there may be three relationships, for example, A and/or B, which may indicate that A exists separately, and both A and B exist, and B exists separately. In addition, the term “at least one” as used herein means any one of multiple elements or any combination of at least two of the multiple elements, for example, including at least one of A, B, or C, which indicates that any one or more elements selected from a set consisting of A, B, and C are included.

In addition, numerous details are given in the following detailed description for the purpose of better explaining the present disclosure. It should be understood by persons skilled in the art that the present disclosure may still be implemented even without some of those details. In some examples, methods, means, elements, and circuits that are well known to persons skilled in the art are not described in detail so that the principle of the present disclosure becomes apparent.

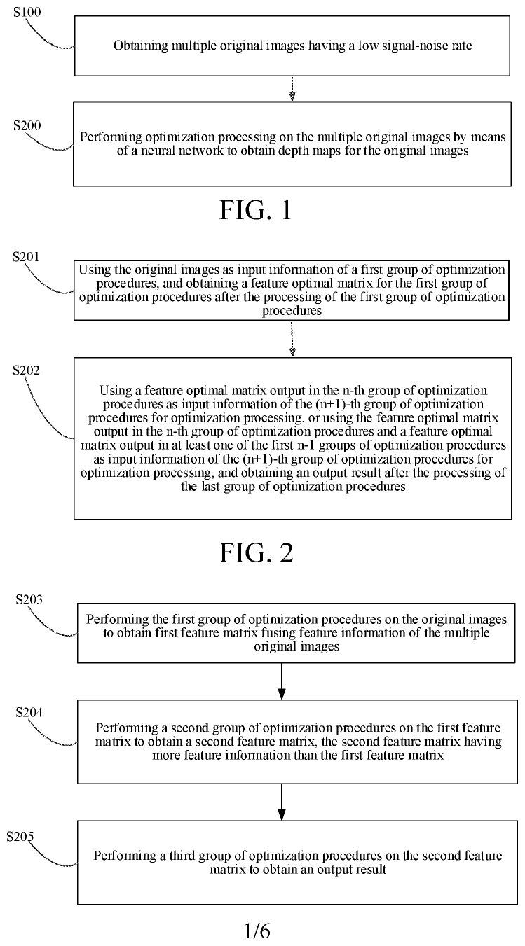

FIG. 1 is a flowchart illustrating an image processing method according to embodiments of the present disclosure. The image processing method of the embodiments of the present disclosure may be applied to an electronic device having a deep camera function or may also be applied to an electronic device capable of performing image processing, for example, to a mobile phone, a camera, a computer device, a smart watch, a wristband, etc., but no limitation is made in the present disclosure. The embodiments of the present disclosure may perform optimization processing on the image of low signal-noise rate under a low exposure rate condition, so that the optimized image may have richer depth information.

At S100, multiple original images which are collected by a TOF sensor in the same exposure process and have a signal-noise rate lower than a first numerical value are obtained, where phase parameter values corresponding to same pixel points in the multiple original images are different.

At S200, optimization processing is performed on the multiple original images by means of a neural network to obtain depth maps corresponding to the multiple original images, where the optimization processing includes at least one convolution processing and at least one nonlinear function mapping processing.

As stated above, the neural network provided in the embodiments of the present disclosure may perform optimization processing on images of low signal-noise rate to obtain images of richer feature information, that is, depth maps of high quality depth information may be obtained. The method of the embodiments of the present disclosure may be applicable to devices having TOF cameras (time of flight cameras). First, the embodiments of the present disclosure may obtain multiple original images having a low signal-noise rate by means of S100, where the original images may be obtained by means of a TOF camera, for example, multiple original images of low signal-noise rate may be collected by means of a TOF sensor in a single exposure process. In the embodiments of the present disclosure, an image with a signal-noise rate lower than a first numerical value may be referred to as a low signal-noise rate image, where the first numerical value may be set according to different conditions, and no specific limitation is made in the present disclosure. In other embodiments, the original images of low signal-noise rate may also be obtained by receiving the original images from other electronic devices. For example, the original images collected by the TOF sensor may be received from other electronic devices and used as optimized objects, and the original images may also be taken by means of a camera device of the device itself The original images obtained in the embodiments of the present disclosure are multiple images obtained in the case of a single exposure for the same subject, and the signal-noise rate of each image is different, and each original image has a different feature matrix. For example, the phase parameter values for the same pixel point in the feature matrix of multiple original images are different. The low signal-noise rate in the embodiments of the present disclosure refers to a low signal-noise rate of the image, where when photographing is performed by the TOF camera, an infrared image may be obtained while obtaining each original image in the case of a single exposure. If the number of pixel points with confidence information corresponding to pixel values in the infrared image lower than a preset value exceeds a preset proportion, it may be indicated that the original image is a low signal-noise rate image, where the preset value may be determined according to the use scenario of the TOF camera, and may be set to 100 in some possible embodiments, but is not intended to specifically define the present disclosure. In addition, the preset proportion may also be set differently according to requirements, for example, may be 30% or other proportions. Persons skilled in the art may determine the low signal-noise rate of the original image according to other settings. In addition, the image obtained at the low exposure rate may also be an image of a low signal-noise rate. Therefore, an image obtained at the low exposure rate may be an object of the original image processed by the embodiments of the present disclosure, and the phase features in each original image are different. The low exposure rate refers to an exposure condition in which the exposure time is less than or equal to 400 microseconds, and in this case, the obtained image has a low signal-noise rate, and the signal-noise rate of the image may be improved by means of the embodiments of the present disclosure, and richer depth information may be obtained from the image, so that the optimized image has more feature information, thereby obtaining a high quality depth image. The original objects obtained by the embodiments of the present disclosure may be two or four, which is not limited in the embodiments of the present disclosure, and may also be other quantitative values.

After obtaining multiple original images of low signal-noise rate, optimization processing may be performed on the original image by using the neural network, the depth information is recovered from the original image, and the depth map corresponding to the original image may be obtained. The original images may be input to the neural network, and optimization processing is performed on the multiple original images by using the neural network, thereby obtaining optimized depth maps. The optimization processing employed in the embodiments of the present disclosure may include at least one convolution processing and at least one nonlinear function mapping processing. The convolution processing may be first performed on the original images, and then the nonlinear function mapping processing may be performed on a convolution processing result. Alternatively, the nonlinear mapping processing may be first performed on the original images, and then the convolution processing may be performed on a nonlinear mapping processing result. Alternatively, the convolution processing and the nonlinear processing may be performed alternately multiple times. For example, the convolution processing may be represented as J, and the nonlinear function mapping processing may be represented as Y, and the optimization processing procedure of the embodiments of the present disclosure may be, for example, JY, BY, JYJJY, YJ, YYJ, YJYYJ, etc., that is, the optimization processing for the original image in the embodiments of the present disclosure may include at least one convolution processing and at least one nonlinear mapping processing, where the sequence and the number of times of each convolution processing and the nonlinear mapping processing may be set by persons skilled in the art according to different needs, and no specific limitation is made in the present disclosure.

The feature information in the feature matrix may be fused by means of convolution processing, and more and more accurate depth information is extracted from the input information, and deeper depth information may be obtained by means of the nonlinear function mapping processing, so as to obtain richer feature information.

In some possible implementations, the performing optimization processing on the multiple original images by means of the neural network to obtain depth maps corresponding to the multiple original images includes:

performing optimization processing on the multiple original images by means of the neural network, and outputting multiple optimized images of the multiple original images, where the signal-noise rate of each optimized image is higher than that of each original image; and

performing post-processing on the multiple optimized images to obtain depth maps corresponding to the multiple original images.

That is to say, the embodiments of the present disclosure may directly obtain multiple optimized images corresponding to multiple original images by means of a neural network. By means of the optimization processing of the neural network, the signal-noise rate of the input original images may be improved, to obtain corresponding optimized images. Further, post-processing is performed on the optimized images to obtain more and more accurate depth maps.

The expression for obtaining the depth maps by means of multiple optimized images may include:

$$d = \frac{c}{4 π f} \cdot arctan [ 2 ( \frac{{r}_{ij}^{{pre}_{3}} - {r}_{ij}^{{pre}_{1}}}{{r}_{ij}^{{pre}_{2}} - {r}_{ij}^{{pre}_{0}}} ) ] \qquad Formula ( 1 )$$

where d represents the depth map, c represents the speed of light, f represents the modulation parameter of the camera, and rᵢⱼ^{pre}^{₀}, rᵢⱼ^{pre}^{₁}, rᵢⱼ^{pre}^{₂}, and rᵢⱼ^{pre}^{₃} are respectively feature values of the i-th row and the j-th column in each original image, i and j are respectively positive integers less than or equal to N, and N represents the dimension (N*N) of the original image.

In some other possible implementations, the performing optimization processing on the multiple original images by means of a neural network to obtain depth maps corresponding to the multiple original images includes: performing optimization processing on the multiple original images by means of the neural network, and outputting the depth maps corresponding to the multiple original images.

That is to say, the neural network in the embodiments of the present disclosure performs optimization processing on multiple original images, so as to directly obtain depth maps corresponding to the multiple original images. The configuration may be implemented in conjunction with the training of neural networks.

It can be known from the above configuration that the embodiments of the present disclosure may directly obtain a depth map with richer and more accurate depth information by means of the optimization processing of the neural network, or may obtain optimized images corresponding to the input original images by means of neural network optimization, and then a depth map having richer and more accurate depth information is obtained further according to post-processing of the optimized image.

In addition, in some possible implementations, before performing optimization processing on the original images by means of the neural network, the embodiments of the present disclosure may further perform a preprocessing operation on the original images to obtain multiple preprocessed original images, and input the multiple preprocessed original images into the neural network for optimization processing, to obtain the depth maps corresponding to the multiple original images. The preprocessing operation may include at least one of the following operations: image calibration, image correction, linear processing between any two original images, or nonlinear processing between any two original images. The image calibration of the original images may eliminate the influence of the reference image in an image obtaining device that obtains the original images, and eliminate the noise brought by the image obtaining device, thereby further improving the accuracy of the original image. The image calibration may be implemented based on the prior art, such as a self-calibration algorithm, and the specific processing procedure of the calibration algorithm is not specifically limited in the present disclosure. Image correction refers to the restorative processing of images. In general, the causes of image distortion include image distortion caused by aberrations, distortion, limited bandwidth, etc. of an imaging system, image geometric distortion caused by the photographing attitude and scanning nonlinearity of the imaging device, and image distortion caused by motion blurring, radiation distortion, noise introduction, etc. Image correction may establish a corresponding mathematical model according to the cause of image distortion to extract the required information from the contaminated or distorted image signal, and restore the original appearance of the image along the inverse process of the image distortion. The process of image correction may eliminate the noise in the original image by means of a filter, thereby improving the accuracy of the original image.

The linear processing between any two original images refers to performing addition or subtraction of the feature values of the corresponding pixel points on the two original images to obtain the result of the linear processing, and the result can be represented as an image feature of a new image.

The nonlinear processing between any two original images refers to nonlinear processing of each pixel point of the original image by using a preset nonlinear function, that is, the feature value of each pixel point may be input into the nonlinear function to obtain a new pixel value, thereby completing the nonlinear processing of each pixel point of the original image, to obtain an image feature of a new image.

After the preprocessing of the original image, the preprocessed image may be input into the neural network, and optimization processing is performed to obtain an optimized depth map. By means of the preprocessing operation, the influence of noise and error in the original image can be reduced, and the accuracy of the depth map may be improved. The optimization process is specifically described below, where the optimization processing procedure of the original image is taken as an example for description, and the optimized processing mode of the preprocessed image is the same as the optimized processing mode of the original image, which is not repeatedly described in the present disclosure.

In the embodiments of the present disclosure, the optimization processing executed by the neural network may include multiple groups of optimization procedures, such as Q groups of optimization procedures, Q being an integer greater than 1, where each group of optimization procedures includes at least one convolution processing and/or at least one nonlinear mapping processing. Different optimization processing may be performed on the original images by means of a combination of the multiple optimization procedures. For example, three groups of optimization procedures, i.e., A, B, and C may be included, where the three optimization procedures may include at least one convolution processing and/or at least one nonlinear mapping processing. However, all the optimization procedures must include at least one convolution processing and at least one nonlinear processing.

FIG. 2 is an exemplary flowchart illustrating optimization processing in the image processing method according to embodiments of the present disclosure, where Q groups of optimization procedures are taken as an example for description.

At S201, the original images are used as input information of a first group of optimization procedures, and a feature optimal matrix for the first group of optimization procedures is obtained after the processing of the first group of optimization procedures.

At S202, a feature optimal matrix output in the n-th group of optimization procedures is used as input information of the (n+1)-th group of optimization procedures for optimization processing, or the feature optimal matrix output in the n-th group of optimization procedures and a feature optimal matrix output in at least one of the first n−1 groups of optimization procedures are used as input information of the (n+1)-th group of optimization procedures for optimization processing, and an output result is obtained based on a feature optimal matrix obtained after the processing of the last group of optimization procedures, where n is an integer greater than 1 and less than Q, and Q is the number of groups in the optimization procedures.

In the embodiments of the present disclosure, the multiple groups of optimization procedures involved in the optimization processing performed by the neural network may sequentially perform further optimization processing on a processing result (the feature optimal matrix) obtained in the former group of optimization procedure, and a processing result obtained in the last group of optimization processing may be used as a depth map or a feature matrix corresponding to the optimized image. In some possible implements, the processing result obtained in the former group of optimization procedures may be directly optimized, that is, only the processing result obtained in the former group of optimization procedures is used as input information of the next group of optimization procedures. In some other possible implementation, a processing result obtained in the former optimization procedure of the current optimization procedure and a result of at least one of the remaining previous optimization procedures except the former optimization processing may also be used as an input (for example, the feature optimal matrices output in the first n groups of optimization procedures are used as input information of the (n+1)-th group of optimization procedures). For example, A, B, and C are three optimization procedures, the input of B may be the output of A, and the input of C may be the output of B, and may also be the output of A and B. That is to say, the input of the first optimization procedure in the embodiments of the present disclosure is an original image. A feature optimal matrix after the optimization processing of the original image may be obtained by means of the first optimization procedure, and in this case, the feature optimal matrix obtained after the optimization processing may be input into a second optimization procedure. The second optimization procedure may further perform optimization processing on the feature optimal matrix obtained in the first optimization procedure, to obtain a feature optimal matrix for the second optimization procedure. The feature optimal matrix obtained in the second optimization procedure may be input into a third feature optimal matrix. In a possible implementation, the third optimization procedure may only use the output of the second feature optimal matrix as input information, and may also simultaneously use the feature optimal matrix obtained in the first optimization procedure and the feature optimal matrix obtained in the second optimization procedure as input information for optimization processing, and so on. The feature optimal matrix output in the n-th group of optimization procedures is used as input information of the (n+1)-th group of optimization procedures for optimization processing, or the feature optimal matrix output in the n-th group of optimization procedures and a feature optimal matrix output in at least one of the first n−1 groups of optimization procedures are used as the input information of the (n+1)-th group of optimization procedures for optimization processing. An optimized result is obtained after the processing of the last group of optimization procedures. The optimized result may be an optimized depth map, or an optimized image corresponding to the original image. By means of the foregoing configuration, persons skilled in the art can construct different optimization procedures according to different requirements, which is not defined in the embodiments of the present disclosure.

In addition, by means of the groups of optimization procedures, feature information in the input information may be continuously fused, and more depth information may be recovered from the feature information, that is, the obtained feature optimal matrix has more features than the input information, and has more depth information.

Convolution kernels used for convolution processing in each group of optimization procedures may be the same or different, and activation functions used for nonlinear mapping processing in each group of optimization procedures may also be the same or different. In addition, the number of convolution kernels used for each convolution processing may also be the same or different, and persons skilled in the art may perform corresponding configurations.

Since the original image obtained by the TOF camera includes phase information of each pixel point, corresponding depth information may be recovered from the phase information by means of the optimization processing in the embodiments of the present disclosure, so as to obtain a depth map having more and more accurate depth information.

As stated in the foregoing embodiments, the optimization processing procedure in S200 may include multiple groups of optimization procedures. Each group of optimization procedures may include at least one convolution processing and at least one nonlinear function mapping processing. In some possible implementations of the present disclosure, each group of optimization procedures may adopt different processing procedures, such as down-sampling, up-sampling, convolution processing, or residual processing. Persons skilled in the art may configure different combinations and processing sequences.

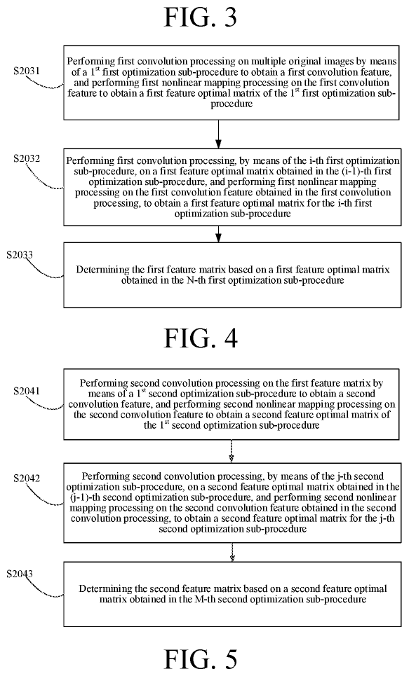

FIG. 3 is another exemplary flowchart illustrating optimization processing in the image processing method according to embodiments of the present disclosure, where the performing optimization processing on the original images may also include:

S203: a first group of optimization procedures is performed on the multiple original images to obtain first feature matrix fusing feature information of the multiple original images.

S204: a second group of optimization procedures is performed on the first feature matrix to obtain a second feature matrix, the second feature matrix having more feature information than the first feature matrix.

S205: a third group of optimization procedures is performed on the second feature matrix to obtain an output result, the feature optimal matrix having more feature information than the second feature matrix.

That is, the optimization processing of the neural network in the embodiments of the present disclosure may include three groups of optimization procedures which are performed sequentially, that is, the neural network may achieve optimization of the original image by means of the first group of optimization procedures, the second group of optimization procedures, and the third group of optimization procedures. In some possible implementations, the first group of optimization procedures may be a down-sampling processing procedure, the second group of optimization procedures may be a residual processing procedure, and the third group of optimization procedures may be an up-sampling processing procedure.

First, the first group of optimization procedures of each original image may be performed by means of S203, feature information of each original image is fused, and depth information in the feature information is recovered to obtain a first feature matrix. On the one hand, the embodiments of the present disclosure may change the size of the feature matrix, such as dimensions of length and width by means of the first group of optimization procedures, and on the other hand, feature information in the feature matrix for each pixel point may be increased, so as to further fuse more features and recover partial depth information therefrom.

FIG. 4 is an exemplary flowchart illustrating a first group of optimization procedures in the image processing method according to embodiments of the present disclosure. The performing the first group of optimization procedures on the multiple original images to obtain first feature matrix fusing feature information of the multiple original images may include:

S2031: first convolution processing is performed on multiple original images by means of a 1^{st} first optimization sub-procedure to obtain a first convolution feature, and first nonlinear mapping processing is performed on the first convolution feature to obtain a first feature optimal matrix.

S2032: first convolution processing is performed, by means of the i-th first optimization sub-procedure, on a first feature optimal matrix obtained in the (i−1)-th first optimization sub-procedure, and first nonlinear mapping processing is performed on the first convolution feature obtained in the first convolution processing, to obtain a first feature optimal matrix for the i-th first optimization sub-procedure.

S2033: the first feature matrix is determined based on a first feature optimal matrix obtained in the N-th first optimization sub-procedure, where i is a positive integer greater than 1 and less than or equal to N, and N represents the number of the first optimization sub-procedures.

The embodiments of the present disclosure may use a down-sampling network to perform the procedure of S203, that is, the first group of optimization procedures may be a procedure of down-sampling processing performed by using the down-sampling network, where the down-sampling network may be a part of network structure in the neural structure. The first group of optimization procedures performed by the down-sampling network in the embodiments of the present disclosure may be used as an optimization procedure of the optimization processing, and the procedure may include multiple first optimization sub-procedures. For example, the down-sampling network may include multiple down-sampling modules. The down-sampling modules may be connected sequentially. Each down-sampling module may include a first convolution unit and a first activation unit. The first activation unit is connected to the first convolution unit to process a feature matrix output by the first convolution unit. Correspondingly, the first group of optimization procedures in S203 may include multiple first optimization sub-procedures, and each first optimization sub-procedure includes first convolution processing and first nonlinear mapping processing. That is, each down-sampling module may perform one first optimization sub-procedure. The first convolution unit in the down-sampling module may perform the first convolution processing, and the first activation unit may perform the first nonlinear mapping processing.

The first convolution processing of each original image obtained in S100 may be performed by means of the 1^{st} first optimization sub-procedure, to obtain a corresponding first convolution feature, and the first nonlinear mapping processing of the first convolution feature is performed by using the first activation function. For example, a first feature optimal matrix of the first down-sampling procedure is finally obtained by multiplying the first activation function by the first convolution feature, or the first convolution feature is substituted into a corresponding parameter of the first activation function to obtain an activation function processing result (the first feature optimal matrix). Correspondingly, the first feature optimal matrix obtained in the 1^{st} first optimization sub-procedure may be used as the input of a 2^{nd} first optimization sub-procedure, the first convolution processing is performed on the first feature optimal matrix of the 1^{st} first optimization sub-procedure by using the 2^{nd} first optimization sub-procedure, to obtain a corresponding first convolution feature, and the first activation processing is performed on the first convolution feature by using the first activation function, to obtain a first feature optimal matrix of the 2^{nd} first optimization sub-procedure.

In a similar fashion, first convolution processing of a first feature optimal matrix obtained in the (i−1)-th first optimization sub-procedure is performed by means of the i-th first optimization sub-procedure, and first nonlinear mapping processing is performed on the first convolution feature obtained in the first convolution processing to obtain a first feature optimal matrix for the i-th first optimization sub-procedure, and the first feature matrix is determined based on a first feature optimal matrix obtained in the N-th first optimization sub-procedure, where i is a positive integer greater than 1 and less than or equal to N, and N represents the number of the first optimization sub-procedures.

When the first convolution processing of each first optimization sub-procedure is performed, first convolution kernels used in each first convolution processing are the same, and the number of first convolution kernels used in the first convolution processing of at least one first optimization sub-procedure is different from the number of first convolution kernels used in the first convolution processing of other first optimization sub-procedures. That is, the convolution kernels used in the first optimization sub-procedures in the embodiments of the present disclosure are first convolution kernels. However, the number of first convolution kernels used in each first optimization sub-procedures may be different, and the adaptive quantity may be selected for different first optimization sub-procedures to perform the first convolution processing. The first convolution kernel may be a 4*4 convolution kernel, or may be other types of convolution kernels, which is not defined in the present disclosure. In addition, the first activation functions used in the first optimization sub-procedures are the same.

In other words, the original image obtained in S100 may be input to the first down-sampling module in the down-sampling network, and a first feature optimal matrix output by the first down-sampling module is input to the second down-sampling module, and so on, and a first feature matrix is processed and output by means of the last first down-sampling module.

First, the first optimization sub-procedure is performed on the original images by using the first convolution unit in the first down-sampling module in the down-sampling network by means of the first convolution kernel, to obtain a first convolution feature corresponding to the first down-sampling module. For example, the first convolution kernel used by the first convolution unit in the embodiments of the present disclosure may be a 4*4 convolution kernel, the first convolution processing may be performed on the original images by using the convolution kernel, and the convolution results of the pixel points are accumulated to obtain a final first convolution feature. Moreover, in the embodiments of the present disclosure, each first convolution unit uses multiple first convolution kernels, the first convolution processing of the original images may be separately performed by means of the multiple first convolution kernels, and the convolution results corresponding to the same pixel points are further summed to obtain a first convolution feature, which is also substantially in the form of a matrix. After the first convolution feature is obtained, the first convolution feature may be processed by using the first activation unit of the first down-sampling module by means of the first activation function, to obtain a first feature optimal matrix for the first down-sampling module. That is, the embodiments of the present disclosure may input the first convolution feature output by the first convolution unit into the first activation unit connected thereto, and process the first convolution feature by using the first activation function, for example, the first activation function is multiplied by the first convolution feature to obtain a first feature optimal matrix of the 1^{st} first down-sampling module.

Further, after the first feature optimal matrix of the first down-sampling module is obtained, the first feature optimal matrix may be processed by using the second down-sampling module to obtain a first feature optimal matrix corresponding to the second down-sampling module, and so on, to respectively obtain a first feature optimal matrix corresponding to each down-sampling module, and finally obtain a first feature matrix. The first convolution kernels used in the first convolution unit in each down-sampling module may be the same convolution kernels, for example, may be 4*4 convolution kernels. However, the number of first convolution kernels used in the first convolution unit in each down-sampling module may be different, such that first convolution features of different sizes may be obtained, thereby obtaining a first feature matrix that fuses different features.

Table 1 is a schematic table illustrating a network structure of an image processing method according to the embodiments of the present disclosure. The down-sampling network may include four down-sampling modules D1-D4. Each down-sampling module may include a first convolution unit and a first activation unit. Each first convolution unit in the embodiments of the present disclosure may perform first convolution processing on the input feature matrix by using the same first convolution kernel. However, the number of first convolution kernels of the first convolution processing performed by each first convolution unit may be different. For example, as can be seen from Table 1, the first down-sampling module D1 may include a convolutional layer and an activation function layer, and the first convolution kernel is a 4*4 convolution kernel. The first convolution processing is performed according to a predetermined stride (for example, 2), where the first convolution unit in the down-sampling module D1 performs the first convolution processing of the input original image by using 64 first convolution kernels to obtain a first convolution feature, which includes feature information of 64 images. After the first convolution feature is obtained, the first activation unit performs processing, for example, the first convolution feature is multiplied by the first activation function to obtain a final first feature optimal matrix of the D1. After the processing of the first activation unit, the feature information may be made richer. Correspondingly, the second down-sampling module D2 may receive from D1 the first feature optimal matrix output thereby, and perform the first convolution processing on the first feature optimal matrix by using the first convolution unit with 128 first convolution kernels. The first convolution kernel is a 4*4 convolution kernel, and the first convolution processing is performed according to a predetermined stride (for example, 2). The first convolution unit in the down-sampling module D2 performs the first convolution processing on the input first feature optimal matrix with 128 first convolution kernels to obtain a first convolution feature, which includes feature information of 128 images. After the first convolution feature is obtained, the first activation unit performs processing, for example, the first convolution feature is multiplied by the first activation function to obtain a final first feature optimal matrix of the D2. After the processing of the first activation unit, the feature information may be made richer.

In a similar fashion, the third down-sampling module D3 may perform a convolution operation on the first feature optimal matrix output by the D2 with 256 first convolution kernels. Similarly, the stride is 2, and the output first convolution feature is further processed by using the first activation unit to obtain a first feature optimal matrix of the D3. Moreover, the fourth down-sampling module D4 may also perform a convolution operation on the first feature optimal matrix of the D3 with 256 first convolution kernels. Similarly, the stride is 2, and the output first convolution feature is processed by using the first activation unit to obtain a first feature optimal matrix of D4, i.e., the first feature matrix.

TABLE 1
Network Architecture

| Name | D1 | D2 | D3 | D4 | Res1-Res9 | U1 | U2 | U3 | U4 |
|---|---|---|---|---|---|---|---|---|---|
| Layer | conv + | conv + | conv + | conv + | ResBlock | deconv + | deconv + | deconv + | deconv + |
| | LeakyReLU | LeakyReLU | LeakyReLU | LeakyReLU | | ReLU | ReLU | ReLU | Tanh |
| Kernel | 4 × 4 | 4 × 4 | 4 × 4 | 4 × 4 | 3 × 3 | 4 × 4 | 4 × 4 | 4 × 4 | 4 × 4 |
| Stride | 2 | 2 | 2 | 2 | 1 | 2 | 2 | 2 | 2 |
| I/O | 4/64 | 64/128 | 128/256 | 256/256 | 256/256 | 256/256 | 512/128 | 256/64 | 128/3 |
| Input | ToF raw | D1 | D2 | D3 | D4 | Res9 | D3 + U1 | D2 + U2 | D1 + U3 |

In the embodiments of the present disclosure, the first convolution kernels used in the down-sampling modules may be the same, and the stride for performing the convolution operation may be the same, but the number of first convolution kernels used by each first convolution unit to perform the convolution operation may be different. After the down-sampling operation is performed by means of each down-sampling module, the feature information of the image may be further enriched, and the signal-noise rate of the image is improved.

After S203 is performed to obtain the first feature matrix, S204 may be performed on the first feature matrix to obtain a second feature matrix. For example, the first feature matrix is input to a residual network, the features are screened by using the residual network, and then the feature information is deepened by using the activation function. Similarly, the residual network may be a separate neural network, and may also be a part of network module in a neural network. The convolution operation in S204 in the embodiments of the present disclosure is a second optimization processing procedure, which may include multiple convolution processing procedures, and each convolution processing procedure includes second convolution processing and second nonlinear mapping processing. The corresponding residual network may include multiple residual blocks, each of which may perform corresponding second convolution processing and second nonlinear mapping processing.

FIG. 5 is an exemplary flowchart illustrating a second group of optimization procedures in the image processing method according to embodiments of the present disclosure. The performing a second group of optimization procedures on the first feature matrix to obtain a second feature matrix may include:

S2041: second convolution processing is performed on the first feature matrix by means of a 1^{st} second optimization sub-procedure to obtain a second convolution feature, and second nonlinear mapping processing is performed on the second convolution feature to obtain a second feature optimal matrix of the 1^{st} second optimization sub-procedure.

S2042: second convolution processing is performed, by means of the j-th second optimization sub-procedure, on a second feature optimal matrix obtained in the (j−1)-th second optimization sub-procedure, and second nonlinear mapping processing is performed on the second convolution feature obtained in the second convolution processing, to obtain a second feature optimal matrix for the j-th second optimization sub-procedure.

S2043: the second feature matrix is determined based on a second feature optimal matrix obtained in the M-th second optimization sub-procedure, where j is a positive integer greater than 1 and less than or equal to M, and M represents the number of the second optimization sub-procedures.

The second group of optimization procedures of S204 in the embodiments of the present disclosure may be another group of optimization procedures, which may perform further optimization operations according to the optimization processing result of S203. The second group of optimization procedures includes multiple second optimization sub-procedures which are performed sequentially, where the second feature optimal matrix obtained by the former second optimization sub-procedure may be used as an input of the next second optimization sub-procedure, so as to sequentially performing the multiple second optimization sub-procedures, and finally a second feature matrix is obtained in the last second optimization sub-procedure, where the input of the 1^{st} second optimization sub-procedure is the first feature matrix obtained in S203.

Specifically, the embodiments of the present disclosure may perform, by means of the 1^{st} second group of optimization procedures, the second convolution processing of the first feature matrix obtained in S203, to obtain a corresponding second convolution feature, and the second nonlinear mapping processing is performed on the second convolution feature to obtain a second feature optimal matrix.

Second convolution processing of a second feature optimal matrix obtained in the (j−1)-th second optimization sub-procedure is performed by means of the j-th second optimization sub-procedure, and second nonlinear mapping processing is performed on the second convolution feature obtained in the second convolution processing to obtain a second feature optimal matrix for the j-th second optimization sub-procedure, and the second feature matrix is determined based on a second feature optimal matrix obtained in the M-th second optimization sub-procedure, where j is a positive integer greater than 1 and less than or equal to M, and M represents the number of the second optimization sub-procedures.

As stated above, in the embodiments of the present disclosure, the second group of optimization procedures is performed by using the residual network, that is, the second group of optimization procedures may be an optimization procedure performed by using the residual network, where the residual network may be a part of network structure in the neural network. The second group of optimization procedures may include multiple second optimization sub-procedures. The residual network may include multiple residual blocks connected sequentially. Each residual block may include a second convolution unit and a second activation unit connected to the second convolution unit for performing the corresponding second optimization sub-procedure.

The second convolution processing of the first feature matrix obtained in S203 may be performed by means of the 1^{st} second optimization sub-procedure, to obtain a corresponding second convolution feature, and the second nonlinear mapping processing of the second convolution feature is performed by using a first activation function. For example, a second feature optimal matrix of the 2^{nd} second down-sampling procedure is finally obtained by multiplying the second activation function by the second convolution feature, or the second convolution feature is substituted into a corresponding parameter of the second activation function to obtain an activation function processing result (the second feature optimal matrix). Correspondingly, the second feature optimal matrix obtained in the 1^{st} second optimization sub-procedure may be used as the input of the 2^{nd} second optimization sub-procedure, the second convolution processing is performed on the second feature optimal matrix of the 1^{st} second optimization sub-procedure by using the 2^{nd} second optimization sub-procedure, to obtain a corresponding second convolution feature, and the second activation processing is performed on the second convolution feature by using the second activation function, to obtain a second feature optimal matrix of the 2^{nd} second optimization sub-procedure. In a similar fashion, the second convolution processing of the second feature optimal matrix obtained in the (j−1)-th second optimization sub-procedure is performed by means of the j-th second optimization sub-procedure, and second nonlinear mapping processing is performed on the second convolution feature obtained in the second convolution processing to obtain a second feature optimal matrix for the j-th second optimization sub-procedure, and the second feature matrix is determined based on a second feature optimal matrix obtained in the M-th second optimization sub-procedure, where j is a positive integer greater than 1 and less than or equal to M, and M represents the number of the second optimization sub-procedures.

When the second convolution processing of each second optimization sub-procedure is performed, second convolution kernels used in each second convolution processing are the same, and the number of second convolution kernels used in the second convolution processing of at least one second optimization sub-procedure is different from the number of second convolution kernels used in the second convolution processing of other second optimization sub-procedures. That is, the convolution kernels used in the first optimization sub-procedures in the embodiments of the present disclosure are second convolution kernels. However, the number of second convolution kernels used in each second optimization sub-procedure may be different, and the adaptive quantity may be selected for different second optimization sub-procedures to perform the second convolution processing. The second convolution kernel may be a 3*3 convolution kernel, or may be other types of convolution kernels, which is not defined in the present disclosure. In addition, the second activation functions used in the second optimization sub-procedures are the same.

In other words, the first feature matrix obtained in S203 may be input to the first residual block in the residual network, and a second feature optimal matrix output by the first residual block is input to the second residual block, and so on, and a second feature matrix is processed and output by means of the last residual block. First, a convolution operation is performed on the first feature matrix by using a second convolution unit in the first residual block in the residual network by means of the second convolution kernel, to obtain a second convolution feature corresponding to the first residual block. For example, the second convolution kernel used by the second convolution unit in the embodiments of the present disclosure may be a 3*3 convolution kernel, the convolution operation may be performed on the first feature matrix by using the convolution kernel, and the convolution results of the pixel points are accumulated to obtain a final second convolution feature. Moreover, in the embodiments of the present disclosure, each second convolution unit uses multiple second convolution kernels, the convolution operation of the first feature matrix may be separately performed by means of the multiple first convolution kernels, and the convolution results corresponding to the same pixel points are further summed to obtain a second convolution feature, which is also substantially in the form of a matrix. After the second convolution feature is obtained, the second activation unit of the first residual block may be used to process the second convolution feature by means of the second activation function, to obtain a second feature optimal matrix for the first residual block. That is, the embodiments of the present disclosure may input the second convolution feature output by the second convolution unit into the second activation unit connected thereto, and process the second convolution feature by using the second activation function, for example, the second activation function is multiplied by the second convolution feature to obtain a second feature optimal matrix of the first residual block.

Further, after the second feature optimal matrix of the first residual block is obtained, the second feature optimal matrix output by the first residual block may be processed by using the second residual block to obtain a second feature optimal matrix corresponding to the second residual block, and so on, to respectively obtain a second feature optimal matrix corresponding to each residual block, and finally obtain a second feature matrix. The second convolution kernel used by the second convolution unit in each residual block may be the same convolution kernels, for example, may be 3*3 convolution kernels, which is not limited in the present disclosure. However, the number of second convolution kernels used by the first convolution unit in each down-sampling module may be the same, so as to ensure rich feature information of the image without changing the size of the feature matrix.

As shown in Table 1, the residual network may include nine residual blocks Res1-Res9. Each residual block may include a second convolution unit and a second activation unit. Each second convolution unit in the embodiments of the present disclosure may perform a convolution operation on the input feature matrix by using the same second convolution kernel. However, the number of second convolution kernels of the convolution operation performed by each second convolution unit may be different. For example, as can be seen from Table 1, the residual block Res1-Res9 may perform the same operation, including a convolution operation of the second convolution unit and a processing operation of the second activation unit. The second convolution kernel may be a 3*3 convolution kernel, and the stride of convolution may be 1, which is not specifically defined in the present disclosure.

Specifically, the second convolution unit in the residual block Res1 performs a convolution operation on the input first feature matrix with 256 second convolution kernels to obtain a second convolution feature, and the first convolution feature is equivalent to including feature information of 256 images. After the second convolution feature is obtained, the second activation unit performs processing, for example, the second convolution feature is multiplied by the second activation function to obtain a final second feature optimal matrix of the Res1. After the processing of the second activation unit, the feature information may be made richer.

Correspondingly, the second residual block Res2 may receive from Res1 the second feature optimal matrix output thereby, and perform the convolution operation on the second feature optimal matrix by using the second convolution unit therein with 256 second convolution kernels. The second convolution kernel is a 3*3 convolution kernel, and the convolution operation is performed according to a predetermined stride (for example, 1). The second convolution unit in the residual block Res2 performs the convolution operation on the input second feature optimal matrix with 256 second convolution kernels to obtain a second convolution feature, which includes feature information of 256 images. After the second convolution feature is obtained, the second activation unit performs processing, for example, the second convolution feature is multiplied by the second activation function to obtain a final second feature optimal matrix of the Res2. After the processing of the second activation unit, the feature information may be made richer.

In a similar fashion, the subsequent residual blocks Res3-9 may perform a convolution operation on the second feature optimal matrix output by the former residual blocks Res2-8 with 256 second convolution kernels. Similarly, the stride is 1, and the output second convolution feature is further processed by using the second activation unit to obtain a second feature optimal matrix of the Res3-9. The second feature optimal matrix output by the Res9 is the second feature matrix output by the residual network. The first feature optimal matrix of D4 is the first feature matrix.

In the embodiments of the present disclosure, the second convolution kernels used in the residual blocks may be the same, and the stride for performing the convolution operation may be the same, but the number of second convolution kernels used by each second convolution unit to perform the convolution operation may also be the same. After the processing is performed by means of each residual block, the feature information of the image may be further enriched, and the signal-noise rate of the image is further improved.

After the second feature matrix is obtained in S204, further optimization may be performed on the second feature matrix by means of the next optimization procedure to obtain an output result. For example, the second feature matrix may be input to an up-sampling network, and the up-sampling network may perform a third group of optimization procedures of the second feature matrix, and can further enrich the depth feature information. When the up-sampling processing procedure is performed, up-sampling processing may be performed on the second feature matrix by using the feature matrix obtained in the down-sampling processing procedure to obtain a feature optimal matrix. For example, optimization processing is performed on the second feature matrix by means of the first feature optimal matrix obtained in the down-sampling processing.

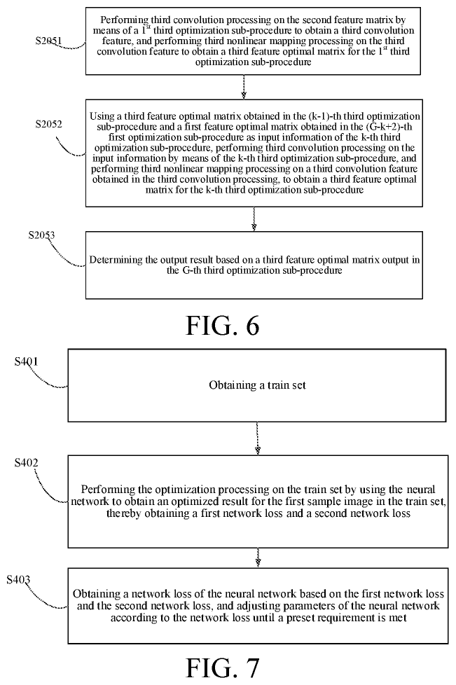

FIG. 6 is an exemplary flowchart illustrating a third group of optimization procedures in the image processing method according to embodiments of the present disclosure. The performing a third group of optimization procedures on the second feature matrix to obtain an output result includes:

S2051: third convolution processing is performed on the second feature matrix by means of a 1^{st} third optimization sub-procedure to obtain a third convolution feature, and third nonlinear mapping processing is performed on the third convolution feature to obtain a third feature optimal matrix for the 1^{st} third optimization sub-procedure.

S2052: a third feature optimal matrix obtained in the (k−1)-th third optimization sub-procedure and a first feature optimal matrix obtained in the (G−k+2)-th first optimization sub-procedure are used as input information of the k-th third optimization sub-procedure, third convolution processing is performed on the input information by means of the k-th third optimization sub-procedure, and third nonlinear mapping processing is performed on a third convolution feature obtained in the third convolution processing, to obtain a third feature optimal matrix for the k-th third optimization sub-procedure.

S2053: a feature optimal matrix corresponding to the output result is determined based on a third feature optimal matrix output in the G-th third optimization sub-procedure, where k is a positive integer greater than 1 and less than or equal to G, and G represents the number of the third optimization sub-procedures.

The embodiments of the present disclosure may perform the procedure of S205 by using the up-sampling network, where the up-sampling network may be a separate neural network, or may be a part of network structure in a neural network, which is not specifically defined in the present disclosure. The third group of optimization procedure performed by the up-sampling network in the embodiments of the present disclosure may be an optimization procedure of the optimization processing, for example, may be an optimization procedure after the optimization processing corresponding to the residual network, and may further perform further optimization on the second feature matrix. The procedure may include multiple third optimization sub-procedures. For example, the up-sampling network may include multiple up-sampling modules, where the up-sampling modules are connected sequentially, and each up-sampling module may include a third convolution unit and a third activation unit. The third activation unit is connected to the third convolution unit to process the output second feature matrix. Correspondingly, the third group of optimization procedures in S205 may include multiple third optimization sub-procedures, and each third optimization sub-procedure includes third convolution processing and third nonlinear mapping processing. That is, each up-sampling module may perform one third optimization sub-procedure. The third convolution unit in the up-sampling module may perform the third convolution processing, and the third activation unit may perform the third nonlinear mapping processing.

The first convolution processing of the second feature matrix obtained in S204 may be performed by means of the 1^{st} third optimization sub-procedure, to obtain a corresponding third convolution feature, and the first nonlinear mapping processing of the third convolution feature is performed by using a third activation function. For example, a third feature optimal matrix of the 1^{st} third optimization sub-procedure is finally obtained by multiplying the third activation function by the third convolution feature, or the third convolution feature is substituted into a corresponding parameter of the third activation function to obtain an activation function processing result (the third feature optimal matrix). Correspondingly, the third feature optimal matrix obtained in the 1^{st} third optimization sub-procedure may be used as the input of the 2^{nd} third optimization sub-procedure, the third convolution processing is performed on the third feature optimal matrix of the 1^{st} third optimization sub-procedure by using the 2^{nd} third optimization sub-procedure, to obtain a corresponding third convolution feature, and the third activation processing is performed on the third convolution feature by using the third activation function, to obtain a third feature optimal matrix of the 2^{nd} third optimization sub-procedure.

In a similar fashion, the third convolution processing of the third feature optimal matrix obtained in the (k−1)-th third optimization sub-procedure is performed by means of the k-th third optimization sub-procedure, and third nonlinear mapping processing is performed on the third convolution feature obtained in the third convolution processing to obtain a third feature optimal matrix for the k-th third optimization sub-procedure, and a feature optimal matrix corresponding to the output result is determined based on a third feature optimal matrix obtained in the G-th third optimization sub-procedure, where k is a positive integer greater than 1 and less than or equal to G, and G represents the number of the third optimization sub-procedures.

Alternatively, in some other possible implementations, from the 2^{nd} third optimization sub-procedure, the third feature optimal matrix obtained in the (k−1)-th third optimization sub-procedure and the first feature optimal matrix obtained in the (G−k+2)-th first optimization sub-procedure are used as input information of the k-th third optimization sub-procedure, the third convolution processing of the input information is performed by means of the k-th third optimization sub-procedure, and the third nonlinear mapping processing is performed on a third convolution feature obtained in the third convolution processing, to obtain a third feature optimal matrix for the k-th third optimization sub-procedure, and a feature optimal matrix corresponding to the output result is determined based on the third feature optimal matrix output in the G-th third optimization sub-procedure, where k is a positive integer greater than 1 and less than or equal to G, and G represents the number of the third optimization sub-procedures. The number of the third optimization sub-procedures is the same as the number of the first optimization sub-procedures included in the first group of optimization procedures.

That is to say, the third feature optimal matrix obtained in the 1^{st} third optimization sub-procedure and the first feature matrix obtained in the G-th first optimization sub-procedure are input to the 2^{nd} third optimization sub-procedure, the third convolution processing is performed on the input information by means of the 2^{nd} third optimization sub-procedure to obtain a third convolution feature, and the nonlinear function mapping processing is performed on the third convolution feature by means of the third activation function to obtain a third feature optimal matrix obtained in the 2^{nd} third optimization sub-procedure. Further, the third feature optimal matrix obtained in the 2^{nd} third optimization sub-procedure and the first feature optimal matrix obtained in the (G−1)-th first optimization sub-procedure are input to the 3^{rd} third optimization sub-procedure, and the third convolution processing and the third activation function processing are performed to obtain the third feature optimal matrix for the 3^{rd} third optimization sub-procedure, and so on, to obtain a third feature optimal matrix corresponding to the last third optimization sub-procedure, i.e., a feature optimal matrix corresponding to the output result.

When the first convolution processing of each up-sampling procedure is performed, third convolution kernels used in each third convolution processing are the same, and the number of third convolution kernels used in the third convolution processing of at least one third optimization sub-procedure is different from the number of third convolution kernels used in the third convolution processing of other third optimization sub-procedures. That is, the convolution kernels used in the up-sampling procedures in the embodiments of the present disclosure are third convolution kernels. However, the number of third convolution kernels used in each third optimization sub-procedure may be different, and the adaptive quantity may be selected for different third optimization sub-procedures to perform the third convolution processing. The third convolution kernel may be a 4*4 convolution kernel, or may be other types of convolution kernels, which is not defined in the present disclosure. In addition, the third activation functions used in the up-sampling procedures are the same.

The embodiments of the present disclosure may perform a third group of optimization procedures on the second feature matrix by using the up-sampling network, to obtain a feature matrix corresponding to the output result. In the embodiments of the present disclosure, the up-sampling network may include multiple up-sampling modules connected sequentially. Each up-sampling module may include a third convolution unit and a third activation unit connected to the third convolution unit.

The second feature matrix obtained in S204 may be input into the first up-sampling module in the up-sampling network, and the third feature optimal matrix outputted by the first up-sampling module is input into the second up-sampling module. Moreover, the first feature optimal matrix outputted in the corresponding down-sampling module may also be input into the corresponding up-sampling module. Therefore, the up-sampling module may simultaneously perform the convolution operations of two input feature matrices to obtain the corresponding third feature optimal matrix, and so on, and a third feature matrix is processed and output by the last up-sampling module.

First, a convolution operation is performed on the second feature matrix by using a third convolution unit in the first up-sampling module in the up-sampling network by means of the third convolution kernel, to obtain a third convolution feature corresponding to the first up-sampling module. For example, the third convolution kernel used by the third convolution unit in the embodiments of the present disclosure may be a 4*4 convolution kernel, the convolution operation may be performed on the second feature matrix by using the convolution kernel, and the convolution results of the pixel points are accumulated to obtain a final second convolution feature. Moreover, in the embodiments of the present disclosure, each third convolution unit uses multiple third convolution kernels, the second group of optimization procedures of the second feature matrix may be separately performed by means of the multiple third convolution kernels, and the convolution results corresponding to the same pixel points are further summed to obtain a third convolution feature, which is also substantially in the form of a matrix. After the third convolution feature is obtained, the third activation unit of the first up-sampling module may be used to process the third convolution feature by means of the third activation function, to obtain a third feature optimal matrix for the first up-sampling module. That is, the embodiments of the present disclosure may input the third convolution feature output by the third convolution unit into the third activation unit connected thereto, and process the third convolution feature by using the third activation function, for example, the third activation function is multiplied by the third convolution feature to obtain a third feature optimal matrix of the first up-sampling module.

Further, after the third feature optimal matrix of the first up-sampling module is obtained, the convolution operation is performed on the third feature optimal matrix output by the first up-sampling module and the first feature optimal matrix output by the corresponding down-sampling module by using the second up-sampling module, to obtain a third feature optimal matrix corresponding to the second up-sampling module, and so on, to respectively obtain the third feature optimal matrices corresponding to the up-sampling modules, so as to finally obtain a third feature matrix. The third convolution kernels used by the third convolution unit in each up-sampling module may be the same convolution kernels, for example, may be 4*4 convolution kernels, which is not limited in the present disclosure. However, the number of the third convolution kernels used by the third convolution unit in each down-sampling module may be different, so that the image matrix may be gradually converted into an image matrix of the same size as the input original image by means of the up-sampling procedure, and the feature information is further increased.

In a possible embodiment, the number of the up-sampling modules in the up-sampling network may be the same as the number of the down-sampling modules in the down-sampling network, and the correspondence of the corresponding up-sampling module and the down-sampling module may be: the k-th up-sampling module corresponds to the (G−k+2)-th down-sampling module, where k is an integer greater than 1, and G is the number of up-sampling modules, i.e., the number of down-sampling modules. For example, the down-sampling module corresponding to the second up-sampling module is the G-th down-sampling module, the down-sampling module corresponding to the third up-sampling module is the (G−1)-th down-sampling module, and the down-sampling module corresponding to the k-th up-sampling module is the (G−k+2)-th down-sampling module.

As shown in Table 1, the embodiments of the present disclosure may include four up-sampling modules U1-U4. Each up-sampling module may include a third convolution unit and a third activation unit. Each third convolution unit in the embodiments of the present disclosure may perform a convolution operation on the input feature matrix by using the same third convolution kernel. However, the number of first convolution kernels of the convolution operation performed by each second convolution unit may be different. For example, as can be seen from Table 1, the up-sampling modules U1-U4 may respectively perform the third group of optimization procedures by using different up-sampling modules, including the convolution operation of the third convolution unit and the processing operation of the third activation unit. The third convolution kernel may be a 4*4 convolution kernel, and the stride of convolution may be 2, which is not specifically defined in the present disclosure.

Specifically, the third convolution unit in the first up-sampling module U1 performs a convolution operation on the input second feature matrix with 256 third convolution kernels to obtain a third convolution feature, and the third convolution feature is equivalent to including feature information of 512 images. After the third convolution feature is obtained, the third activation unit performs processing, for example, the third convolution feature is multiplied by the third activation function to obtain a final third feature optimal matrix of the U1. After the processing of the third activation unit, the feature information may be made richer.

Correspondingly, the second up-sampling module U2 may receive the third feature optimal matrix output thereby and the first feature matrix output by the D4 from the U1, and perform the convolution operation on the third feature optimal matrix output by the U1 and the first feature matrix output by the D4 by using the third convolution unit therein with 128 second convolution kernels. The second convolution kernels are 4*4 convolution kernels, and the convolution operation is performed according to a predetermined stride (for example, 2), and the third convolution unit in the up-sampling module U2 performs the convolution operation by using 128 third convolution kernels, to obtain a third convolution feature which includes feature information of 256 images. After the third convolution feature is obtained, the third activation unit performs processing, for example, the third convolution feature is multiplied by the third activation function to obtain a final third feature optimal matrix of the U2. After the processing of the third activation unit, the feature information may be made richer.

Further, the third up-sampling module U3 may receive the third feature optimal matrix output thereby and the first feature optimal matrix output by the D3 from the U2, and perform the convolution operation on the third feature optimal matrix output by the U2 and the first feature matrix output by the D3 by using the third convolution unit therein with 64 second convolution kernels. The second convolution kernels are 4*4 convolution kernels, and the convolution operation is performed according to a predetermined stride (for example, 2), and the third convolution unit in the up-sampling module U3 performs the convolution operation by using 64 third convolution kernels, to obtain a third convolution feature which includes feature information of 128 images. After the third convolution feature is obtained, the third activation unit performs processing, for example, the third convolution feature is multiplied by the third activation function to obtain a final third feature optimal matrix of the U3. After the processing of the third activation unit, the feature information may be made richer.

Further, the fourth up-sampling module U4 may receive the third feature optimal matrix output thereby and the first feature optimal matrix output by the D2 from the U3, and perform the convolution operation on the third feature optimal matrix output by the U3 and the first feature optimal matrix output by the D2 by using the third convolution unit therein with three second convolution kernels. The second convolution kernels are 4*4 convolution kernels, and the convolution operation is performed according to a predetermined stride (for example, 2), and the third convolution unit in the up-sampling module U4 performs the convolution operation by using three third convolution kernels, to obtain a third convolution feature. After the third convolution feature is obtained, the third activation unit performs processing, for example, the third convolution feature is multiplied by the third activation function to obtain a final third feature optimal matrix of the U4. After the processing of the third activation unit, the feature information may be made richer.

In the embodiments of the present disclosure, the third convolution kernels used in the up-sampling modules may be the same, and the stride for performing the convolution operation may be the same, but the number of third convolution kernels used by each third convolution unit to perform the convolution operation may be different. After the processing is performed by means of each up-sampling module, the feature information of the image may be further enriched, and the signal-noise rate of the image is improved.

A third feature matrix is obtained after the processing of the last up-sampling module. The third feature matrix may be depth maps corresponding to multiple original images, has the same size as the original image, and includes rich feature information (depth information, etc.), thereby improving the signal-noise rate of the image, and the optimized image can be obtained by using the third feature matrix.

In addition, the third feature matrix outputted by the neural network may also be a feature matrix of the optimized image corresponding to multiple original images, and multiple corresponding optimized images may be obtained by means of the third feature matrix. The optimized image has more accurate feature values than the original image, and an optimized depth map may be obtained from the obtained original image.

In the embodiments of the present disclosure, each network may also be trained using training data prior to the image optimization procedure by means of the down-sampling network, the up-sampling network, and the residual network. The embodiments of the present disclosure may train a neural network by inputting a first training image into a neural network based on the image information neural network formed by the down-sampling network, the up-sampling network, and the residual network. The neural network in the embodiments of the present disclosure is a generative network in a generative adversarial network obtained by training.

In some possible implementations, for the case where the neural network may directly output the depth map of the original image, during training of the neural network, the train set may be input into the neural network, the train set including multiple training samples, where each training sample may include multiple first sample images and ground truth depth maps corresponding to the multiple first sample images. Optimization processing is performed on the input training samples by means of the neural network to obtain a predicted depth map corresponding to each training sample. Network loss may be obtained by using the difference between the ground truth depth map and the predicted depth map, and the network parameters may be adjusted according to the network loss until the training requirements are met. The training requirement is that the network loss determined by the difference between the ground truth depth map and the predicted depth map is less than a loss threshold, and the loss threshold may be a preconfigured value, such as 0.1, which is not specifically limited in the present disclosure. The expression for the network loss may be:

$${L}_{depth} = \frac{1}{N} {\sum }_{i , j}^{N} \vert {d}_{ij}^{gt} - {d}_{ij}^{pre} \vert \qquad Formula ( 2 )$$

where L_{depth} represents the network loss (i.e., the depth loss), N represents the dimension of the original image (N*N dimensions), i and j respectively represent the positions of the pixel points, dᵢⱼ^{gt} represents the real pixel point of the i-th row and the j-th column in the ground truth depth map, and dᵢⱼ^{pre} represents a predicted depth value of a pixel point of the i-th row and the j-th column in the predicted depth map, where i and j are integers greater than or equal to 1 and less than or equal to N, respectively.

By means of the above process, the network loss of the neural network may be obtained, and the network parameters for adjusting the neural network may be fed back according to the network loss until the obtained network loss is less than the loss threshold. In this case, it can be determined that the training requirement is met, and the obtained neural network may accurately obtain the depth map corresponding to the original image.

In addition, in the case where the neural network obtains an optimized image corresponding to the original image, the embodiments of the present disclosure may supervise the training process of the neural network based on the depth loss and the image loss. FIG. 7 is another flowchart illustrating the image processing method according to embodiments of the present disclosure. As shown in FIG. 5, the method in the embodiments of the present disclosure further includes a neural network training process, which may include:

S401: a train set is obtained, where the train set includes multiple training samples, each training sample may include multiple first sample images, multiple second sample images corresponding to the multiple first sample images, and depth maps corresponding to the multiple second sample images, where the second sample image and the corresponding first sample image are images for the same object, and the signal-noise rate of the second sample image is higher than that of the first sample image.

S402: the optimization processing is performed on the train set by using the neural network to obtain an optimized result for the first sample image in the train set, thereby obtaining a first network loss and a second network loss, where the first network loss is obtained based on differences between multiple predicted optimization images obtained by processing multiple first sample images included in the training sample by means of the neural network and the multiple second sample images included in the training sample, and the second network loss is obtained based on differences between predicted depth maps obtained by post-processing the multiple predicted optimization images and depth maps included in the training sample.

S403: a network loss of the neural network is obtained based on the first network loss and the second network loss, and parameters of the neural network are adjusted according to the network loss until a preset requirement is met.

The embodiments of the present disclosure may input multiple training samples into a neural network, each training sample may include multiple images (first sample images) of low signal-noise rate, such as image information obtained in low exposure rate. The first sample image may be obtained by using an EPC660 ToF camera and Sony's IMX316 Minikit development kit in different scenarios such as a laboratory, an office, a bedroom, a living room, and a restaurant. The present disclosure does not specifically limit the collection device and the collection scene, as long as the first training image at a low exposure rate may be obtained, it can be taken as an embodiment of the present disclosure. The first sample image in the embodiments of the present disclosure may include 200 (or other number) groups of data, each group of data including TOF raw measurement data, depth maps, and amplitude maps at low exposure time such as 200 us and 400 us and normal exposure time or long exposure time, where TOF raw measurement data may be used as the first sample image. The corresponding feature optimal matrix is obtained by means of the optimization processing of the neural network. For example, the optimization processing of multiple first sample images in the training sample may be performed by means of the down-sampling network, the residual network, and the up-sampling network, to finally obtain feature optimal matrices respectively corresponding to the first sample images, i.e., the predicted optimization images. The embodiments of the present disclosure may compare the feature optimal matrix corresponding to the first sample image with the standard feature matrix, that is, compare the predicted optimization image with the corresponding second sample image to determine the difference therebetween. The standard feature matrix is a feature matrix of the second sample image corresponding to each image in the first training image, i.e., an image feature matrix having accurate feature information (phase, amplitude, pixel value, and the like). The first network loss of the neural network may be determined by comparing the predicted feature optimal matrix with the standard feature matrix.

The case where each training sample includes four first sample images is taken as an example for description, the expression of the first network loss may be:

$${L}_{raw} = \frac{1}{N} {\sum }_{i , j}^{N} [ \vert {r}_{ij}^{{gt}_{0}} - {r}_{ij}^{{pre}_{0}} \vert + \vert {r}_{ij}^{{gt}_{1}} - {r}_{ij}^{{pre}_{1}} \vert \vert {r}_{ij}^{{gt}_{2}} - {r}_{ij}^{{pre}_{2}} \vert \vert {r}_{ij}^{{gt}_{3}} - {r}_{ij}^{{pre}_{3}} \vert ] \qquad Formula ( 3 )$$

where L_{raw} represents the first network loss, N represents the dimension (N*N) of the first sample image, the second sample image, and the predicted optimization image, rᵢⱼ^{gt}^{₀}, rᵢⱼ^{gt}^{₁}, rᵢⱼ^{gt}^{₁}, and rᵢⱼ^{gt}^{₃} respectively represent the real feature values of the i-row and the j-th column of four first sample images in the training sample, and rᵢⱼ^{pre}^{₀}, rᵢⱼ^{pre}^{₁}, rᵢⱼ^{pre}^{₂}, and rᵢⱼ^{pre}^{₃} respectively represent the predicted feature values of the i-th row and the j-th column of the four predicted optimization images corresponding to the four first sample images.

The first network loss may be obtained by means of the foregoing method. In addition, in a case where a predicted optimization image corresponding to each first sample image in the training sample is obtained, a predicted depth map corresponding to the multiple first sample images may be further determined according to the obtained predicted optimization image, i.e., performing the post-processing of the predicted optimization image, and the specific method may be defined with reference to Formula (1).

Correspondingly, after the predicted depth map is obtained, the second network loss, i.e., the depth loss may be further determined. The second network loss may be specifically obtained according to Formula (2), and details are not described herein again.

After the first network loss and the second network loss are obtained, the network loss of the neural network may be obtained by using a weighted sum of the first network loss and the second network loss. The network loss of the neural network is expressed as:

L=αL_{depth}+βL_{raw} Formula (4)

L represents the network loss of the neural network, α and β are respectively the weight of the first network loss and the second network loss, where the weighted values may be set according to requirements, for example, the weighted values may be 1, or the weighted sum of α and β may be 1, which is not specifically defined in the present disclosure.

In a possible implementation, parameters for adjusting the neural network, such as the convolution kernel parameter, and the activation function parameter may be fed back based on the obtained network parameters. For example, parameters of the down-sampling network, the residual network, and the up-sampling network may be adjusted, or the difference may be input to a fitness function, and parameters in the optimization processing procedure and the parameters of the down-sampling network, the residual network, and the up-sampling network are adjusted according to the obtained parameter values. Optimization processing is then performed on the training sample again by means of the neural network with the parameters adjusted, to obtain a new optimized result. The process above is repeated until the obtained network loss meets the preset training requirement, for example, the network loss is less than the preset loss threshold. If the obtained network loss meets the preset training requirement, it is indicated that the training of the neural network is completed, and in this case, the optimization procedure is performed on the low signal-noise rate image according to the trained neural network, and the optimization precision is higher.

Further, in order to further ensure the optimization precision of the neural network, the embodiments of the present disclosure may also further verify the optimized result of the trained neural network by using the adversarial network. If the determined result indicates that the network needs to be further optimized, parameters of the neural network may be further adjusted, until the determined result of the adversarial network indicates that the neural network achieves a better optimization effect.

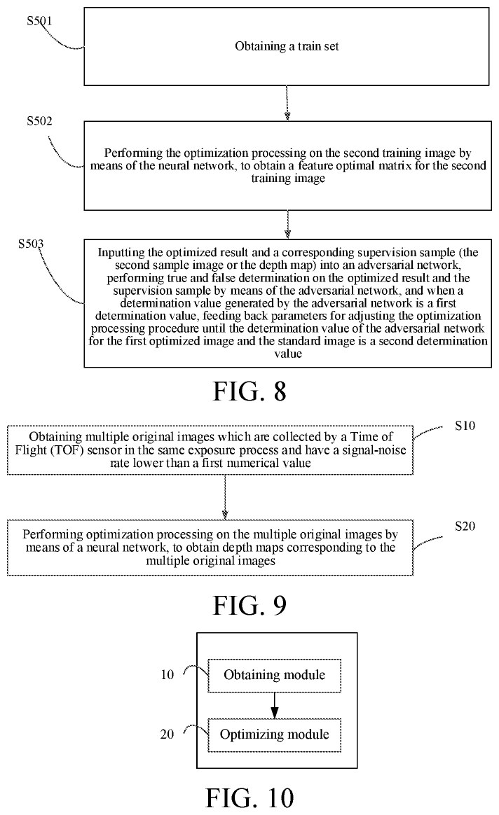

FIG. 8 is another flowchart illustrating the image processing method according to embodiments of the present disclosure. In the embodiments of the present disclosure, after the S502, the method may also include:

S501: a train set is obtained, where the train set includes multiple training samples, each training sample may include multiple first sample images, multiple second sample images corresponding to the multiple first sample images, and depth maps corresponding to the multiple second sample images.

S502: the optimization processing is performed on the training sample by using the neural network, to obtain an optimized result.

In some possible implementations, the obtained optimized result may be a predicted optimization image obtained by the neural network and corresponding to the first sample image, or may also be a predicted depth map corresponding to the first sample image.

S503: the optimized result and a corresponding supervision sample (the second sample image or the depth map) are input into an adversarial network, true and false determination is performed on the optimized result and the supervision sample by means of the adversarial network, and when the determination result generated by the adversarial network is a first determination result, parameters for adjusting the optimization processing procedure is fed back until the determination value of the adversarial network for the first optimized image and the standard image is a second determination value.

In the embodiments of the present disclosure, after the neural network is trained by means of S401 to S403, further optimization may also be performed on the generated network (the neural network) by using the adversarial network, and the train set in S501 and the train set in S401 may be the same or different, which is not defined in the present disclosure.

When the optimized result of the training sample in the train set is obtained by means of the neural network, the optimized result may be input into the adversarial network, and meanwhile the corresponding supervision sample (i.e., the real and clear second sample image or depth map) may also be input into the adversarial network. The adversarial network may make true and false determination on the optimized result and the supervision sample, that is, if the difference between the optimized result and the supervision sample is less than the third threshold, the adversarial network may output a second determination value, such as 1, indicating that the optimized neural network has high optimization precision. The adversarial network cannot determine which one of the optimized result and supervision sample is true or false. In this case, no further training on the neural network is required.

If the difference between the optimized result and the supervision sample is greater than or equal to the third threshold, the adversarial network may output a first determination value, such as 0, indicating that the optimization precision of the optimized neural network is not high, and the adversarial network may distinguish the optimized result from the supervision sample. In this case, further training on the neural network is required. That is, the parameters for adjusting the neural network are fed back according to the difference between the optimized result and the supervision sample until the determination value of the adversarial network for the optimized result and the supervision sample is the second determination value. By means of the above configuration, the optimization precision of the image neural network can be further improved.

In summary, the embodiments of the present disclosure may be applied to an electronic device having a deep camera function, such as a TOF camera, and the depth map may be recovered from the original image data with low signal-noise rate by means of the embodiments of the present disclosure, so that the optimized image has high resolution, high frame rate and other effects, which can be achieved without loss of precision. The method provided by the embodiments of the present disclosure may be applied to a TOF camera module of an unmanned driving system, thereby achieving a farther detection range and higher detection accuracy. In addition, the embodiments of the present disclosure may also be applied to smart phones and intelligent security monitoring to reduce the power consumption of the module without affecting the measurement accuracy, so that the TOF module does not affect the endurance of the smart phone and the security monitoring.

In addition, the embodiments of the present disclosure further provide an image processing method. FIG. 9 is another flowchart illustrating the image processing method according to embodiments of the present disclosure. The image processing method may include:

S10: multiple original images which are collected by a TOF sensor in the same exposure process and have a signal-noise rate lower than a first numerical value are obtained, where phase parameter values corresponding to same pixel points in the multiple original images are different.

S20: optimization processing is performed on the multiple original images by means of a neural network to obtain depth maps corresponding to the multiple original images, where the neural network is obtained by training a train set, each of multiple training samples included in the train set includes multiple first sample images, multiple second sample images corresponding to the multiple first sample images, and depth maps corresponding to the multiple second sample images, where the second sample image and the corresponding first sample image are images for the same object, and the signal-noise rate of the second sample image is higher than that of the first sample image.

In some possible implementations, the performing optimization processing on the multiple original images by means of a neural network to obtain depth maps corresponding to the multiple original images includes: performing optimization processing on the multiple original images by means of the neural network, and outputting multiple optimized images of the multiple original images, where the signal-noise rate of each optimized image is higher than that of each original image; and performing post-processing on the multiple optimized images to obtain depth maps corresponding to the multiple original images.

In some possible implementations, the performing optimization processing on the multiple original images by means of a neural network to obtain depth maps corresponding to the multiple original images includes: performing optimization processing on the multiple original images by means of the neural network, and outputting the depth maps corresponding to the multiple original images.

In some possible implementations, the performing optimization processing on the multiple original images by means of a neural network to obtain depth maps corresponding to the multiple original images includes: inputting the multiple original images into the neural network for optimization processing, to obtain the depth maps corresponding to the multiple original images.

In some possible implementations, the method further includes: performing preprocessing on the multiple original images to obtain the multiple preprocessed original images, the preprocessing including at least one of the following operations: image calibration, image correction, linear processing between any two original images, or nonlinear processing between any two original images. The performing optimization processing on the multiple original images by means of the neural network to obtain depth maps corresponding to the multiple original images includes: inputting the multiple preprocessed original images into the neural network for optimization processing, to obtain the depth maps corresponding to the multiple original images.

In some possible implementations, the optimization processing performed by the neural network includes Q groups of optimization procedures which are performed sequentially, and each group of optimization procedures includes at least one convolution processing and/or at least one nonlinear mapping processing; where the performing optimization processing on the multiple original images by means of the neural network includes:

using the multiple original images as input information of a first group of optimization procedures, and obtaining a feature optimal matrix for the first group of optimization procedures after the processing of the first group of optimization procedures; using a feature optimal matrix output in the n-th group of optimization procedures as input information of the (n+1)-th group of optimization procedures for optimization processing, or using feature optimal matrices output in the first n groups of optimization procedures as input information of the (n+1)-th group of optimization procedures for optimization processing, where n is an integer greater than 1 and less than Q; and obtaining an output result based on a feature optimal matrix obtained after the processing of the Q-th group of optimization procedures.

In some possible implementations, the Q groups of optimization procedures include down-sampling processing, residual processing, and up-sampling processing which are performed sequentially, and the performing optimization processing on the multiple original images by means of the neural network includes: performing the down-sampling processing on the multiple original images to obtain first feature matrix fusing feature information of the multiple original images; performing the residual processing on the first feature matrix to obtain a second feature matrix; and performing the up-sampling processing on the second feature matrix to obtain a feature optimal matrix, where the output result of the neural network is obtained based on the feature optimal matrix. In some possible implementations, before the performing the up-sampling processing on the second feature matrix to obtain a feature optimal matrix, the method further includes:

using a feature matrix obtained in the down-sampling processing procedure to perform the up-sampling processing on the second feature matrix to obtain the feature optimal matrix.

In some possible implementations, the neural network is a generative network in a generative adversarial network obtained by training; a network loss value of the neural network is a weighted sum of a first network loss and a second network loss, where the first network loss is obtained based on differences between multiple predicted optimization images obtained by processing the multiple first sample images included in the training sample by means of the neural network and the multiple second sample images included in the training sample, and the second network loss is obtained based on differences between predicted depth maps obtained by post-processing the multiple predicted optimization images and depth maps included in the training sample.

A person skilled in the art can understand that, in the foregoing methods of the specific implementations, the order in which the steps are written does not imply a strict execution order which constitutes any limitation to the implementation process, and the specific order of executing the steps should be determined by functions and possible internal logics thereof.

It should be understood that the foregoing various method embodiments mentioned in the present disclosure may be combined with each other to form a combined embodiment without departing from the principle logic. Details are not described herein again due to space limitation.

In addition, the present disclosure further provides an image processing apparatus, an electronic device, a computer-readable storage medium, and a program, which can all be used to implement any of the image processing methods provided by the present disclosure. For the corresponding technical solutions and descriptions, please refer to the corresponding content in the method section. Details are not described herein again.

FIG. 10 is a block diagram illustrating an image processing apparatus according to embodiments of the present disclosure. As shown in FIG. 10, the image processing apparatus includes:

an obtaining module 10, configured to obtain multiple original images which are collected by a TOF sensor in the same exposure process and have a signal-noise rate lower than a first numerical value, where phase parameter values corresponding to same pixel points in the multiple original images are different; and

an optimizing module 20, configured to perform optimization processing on the multiple original images by means of a neural network to obtain depth maps corresponding to the multiple original images, where the processing includes at least one convolution processing and at least one nonlinear function mapping processing.

In some possible implementations, the optimizing module is further configured to perform optimization processing on the multiple original images by means of the neural network, and output multiple optimized images of the multiple original images, where the signal-noise rate of each optimized image is higher than that of each original image; and perform post-processing on the multiple optimized images to obtain depth maps corresponding to the multiple original images.

In some possible implementations, the optimizing module is further configured to perform optimization processing on the multiple original images by means of the neural network, and output the depth maps corresponding to the multiple original images.

In some possible implementations, the optimizing module is further configured to input the multiple original images into the neural network for optimization processing, to obtain the depth maps corresponding to the multiple original images.

In some possible implementations, the apparatus further includes a preprocessing module, configured to perform preprocessing on the multiple original images to obtain the multiple preprocessed original images, where the preprocessing includes at least one of the following operations: image calibration, image correction, linear processing between any two original images, or nonlinear processing between any two original images; and the optimizing module is further configured to input the multiple preprocessed original images into the neural network for optimization processing, to obtain the depth maps corresponding to the multiple original images.

In some possible implementations, the optimization processing performed by the optimizing module includes Q groups of optimization procedures which are performed sequentially, and each group of optimization procedures includes at least one convolution processing and/or at least one nonlinear mapping processing; and the optimizing module is further configured to use the original image as the input information of the first group of optimization procedures, and obtain a feature optimal matrix for the first group of optimization procedures after the processing of the first group of optimization procedures; and use a feature optimal matrix output in the n-th group of optimization procedures as input information of the (n+1)-th group of optimization procedures for optimization processing, or use feature optimal matrices output in the first n groups of optimization procedures as input information of the (n+1)-th group of optimization procedures for optimization processing, and obtain an output result based on a feature optimal matrix obtained after the processing of the Q-th group of optimization procedures, where n is an integer greater than 1 and less than Q, and Q is the number of groups in the optimization procedures.

In some possible implementations, the Q groups of optimization procedures include down-sampling processing, residual processing, and up-sampling processing which are performed sequentially, and the optimizing module includes: a first optimizing unit, configured to perform the down-sampling processing on the multiple original images to obtain first feature matrix fusing feature information of the multiple original images; a second optimizing unit, configured to perform the residual processing on the first feature matrix to obtain a second feature matrix; and a third optimizing unit, configured to perform the up-sampling processing on the second feature matrix to obtain a feature optimal matrix, where the output result of the neural network is obtained based on the feature optimal matrix.

In some possible implementations, the third optimizing unit is further configured to use a feature matrix obtained in the down-sampling processing procedure to perform the up-sampling processing on the second feature matrix to obtain the feature optimal matrix.

In some possible implementations, the neural network is obtained by training a train set, where each of multiple training samples included in the train set includes multiple first sample images, multiple second sample images corresponding to the multiple first sample images, and depth maps corresponding to the multiple second sample images, where the second sample image and the corresponding first sample image are images for the same object, and the signal-noise rate of the second sample image is higher than that of the first sample image; where the neural network is a generative network in a generative adversarial network obtained by training; a network loss value of the neural network is a weighted sum of a first network loss and a second network loss, where the first network loss is obtained based on differences between multiple predicted optimization images obtained by processing the multiple first sample images included in the training sample by means of the neural network and the multiple second sample images included in the training sample, and the second network loss is obtained based on differences between predicted depth maps obtained by post-processing the multiple predicted optimization images and depth maps included in the training sample.

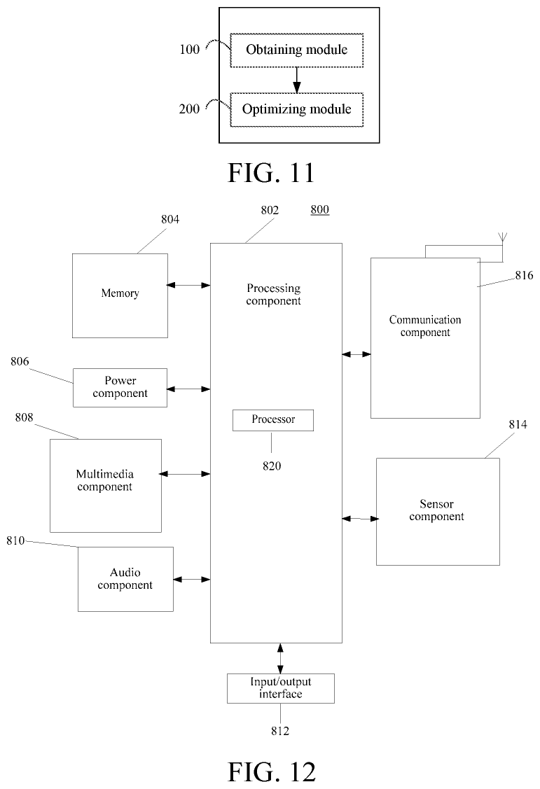

FIG. 11 is another block diagram illustrating the image processing apparatus according to embodiments of the present disclosure. The image processing apparatus may include:

an obtaining module 100, configured to obtain multiple original images which are collected by a TOF sensor in the same exposure process and have a signal-noise rate lower than a first numerical value, where phase parameter values corresponding to same pixel points in the multiple original images are different; and

an optimizing module 200, configured to perform optimization processing on the multiple original images by means of a neural network to obtain depth maps corresponding to the multiple original images, where the neural network is obtained by training a train set, each of multiple training samples included in the train set includes multiple first sample images, multiple second sample images corresponding to the multiple first sample images, and depth maps corresponding to the multiple second sample images, where the second sample image and the corresponding first sample image are images for the same object, and the signal-noise rate of the second sample image is higher than that of the corresponding first sample image.

In some possible implementations, the optimizing module is further configured to perform optimization processing on the multiple original images by means of the neural network, and output multiple optimized images of the multiple original images, where the signal-noise rate of each optimized image is higher than that of each original image; and perform post-processing on the multiple optimized images to obtain depth maps corresponding to the multiple original images.

In some possible implementations, the optimizing module is further configured to perform optimization processing on the multiple original images by means of the neural network, and output the depth maps corresponding to the multiple original images.

In some possible implementations, the optimizing module is further configured to input the multiple original images into the neural network for optimization processing, to obtain the depth maps corresponding to the multiple original images.

In some possible implementations, the apparatus further includes a preprocessing module, configured to perform preprocessing on the multiple original images to obtain the multiple preprocessed original images, where the preprocessing includes at least one of the following operations: image calibration, image correction, linear processing between any two original images, or nonlinear processing between any two original images; and the optimizing module is further configured to input the multiple preprocessed original images into the neural network for optimization processing, to obtain the depth maps corresponding to the multiple original images.

In some possible implementations, the optimization processing performed by the neural network includes Q groups of optimization procedures which are performed sequentially, and each group of optimization procedures includes at least one convolution processing and/or at least one nonlinear mapping processing; where the optimizing module is further configured to: use the multiple original images as input information of the first group of optimization procedures, and obtain a feature optimal matrix for the first group of optimization procedures after the processing of the first group of optimization procedures; use a feature optimal matrix output in the n-th group of optimization procedures as input information of the (n+1)-th group of optimization procedures for optimization processing, or use feature optimal matrices output in the first n groups of optimization procedures as input information of the (n+1)-th group of optimization procedures for optimization processing, where n is an integer greater than 1 and less than Q; and obtain an output result based on a feature optimal matrix obtained after the processing of the Q-th group of optimization procedures.

In some possible implementations, the Q groups of optimization procedures include down-sampling processing, residual processing, and up-sampling processing which are performed sequentially, and the optimizing module includes: a first optimizing unit, configured to perform the residual processing on the first feature matrix to obtain a second feature matrix; and a second optimizing unit, configured to perform the up-sampling processing on the second feature matrix to obtain a feature optimal matrix, where the output result of the neural network is obtained based on the feature optimal matrix.

In some possible implementations, the neural network is a generative network in a generative adversarial network obtained by training; a network loss value of the neural network is a weighted sum of a first network loss and a second network loss, where the first network loss is obtained based on differences between multiple predicted optimization images obtained by processing the multiple first sample images included in the training sample by means of the neural network and the multiple second sample images included in the training sample, and the second network loss is obtained based on differences between predicted depth maps obtained by post-processing the multiple predicted optimization images and depth maps included in the training sample.

In some embodiments, the functions provided by or the modules included in the apparatuses provided by the embodiments of the present disclosure may be used to implement the methods described in the foregoing method embodiments. For specific implementations, reference may be made to the description in the method embodiments above. For the purpose of brevity, details are not described herein again.

The embodiments of the present disclosure further provide a computer-readable storage medium, having computer program instructions stored thereon, where when the computer program instructions are executed by a processor, the foregoing methods are implemented. The computer-readable storage medium may include a nonvolatile computer-readable storage medium or a volatile computer-readable storage medium.

The embodiments of the present disclosure further provide an electronic device, including: a processor; and a memory configured to store processor-executable instructions, where the processor is configured to execute the foregoing methods.

The embodiments of the present disclosure further provide a computer program, including computer readable codes, where when the computer readable codes run in an electronic device, a processor in the electrode device executes the foregoing methods.

The electronic device may be provided as a terminal, a server, or other forms of devices.

FIG. 12 is a block diagram illustrating an electronic device according to embodiments of the present disclosure. For example, the electronic device 800 may be a terminal such as a mobile phone, a computer, a digital broadcast terminal, a message transceiver device, a game console, a tablet device, a medical device, exercise equipment, and a personal digital assistant.

Referring to FIG. 12, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 generally controls overall operation of the electronic device 800, such as operations associated with display, phone calls, data communications, camera operations, and recording operations. The processing component 802 may include one or more processors 820 to execute instructions to implement all or some of the steps of the methods above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, and etc. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power component 806 provides power for various components of the electronic device 800. The power component 806 may include a power management system, one or more power supplies, and other components associated with power generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the electronic device 800 is in an operation mode, such as a calling mode, a recording mode, and a voice recognition mode. The received audio signal may be further stored in the memory 804 or transmitted by means of the communication component 816. In some embodiments, the audio component 810 further includes a speaker for outputting the audio signal.

The I/O interface 812 provides an interface between the processing component 802 and a peripheral interface module, which may be a keyboard, a click wheel, a button, etc. The button may include, but is not limited to, a home button, a volume button, a start button, and a lock button.

The sensor component 814 includes one or more sensors for providing state assessment in various aspects for the electronic device 800. For example, the sensor component 814 may detect an on/off state of the electronic device 800, and relative positioning of components, which are the display and keypad of the electronic device 800, for example, and the sensor component 814 may further detect a position change of the electronic device 800 or a component of the electronic device 800, the presence or absence of contact of the user with the electronic device 800, the orientation or acceleration/deceleration of the electronic device 800, and a temperature change of the electronic device 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the electronic device 800 and other devices. The electronic device 800 may access a wireless network based on a communication standard, such as WiFi, 2G, or 3G, or a combination thereof. In an exemplary embodiment, the communication component 816 receives a broadcast signal or broadcast-related information from an external broadcast management system by means of a broadcast channel. In an exemplary embodiment, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology, and other technologies.

In an exemplary embodiment, the electronic device 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the method above.

In an exemplary embodiment, a non-volatile computer-readable storage medium is further provided, for example, a memory 804 including computer program instructions, which can executed by the processor 820 of the electronic device 800 to implement the methods above.

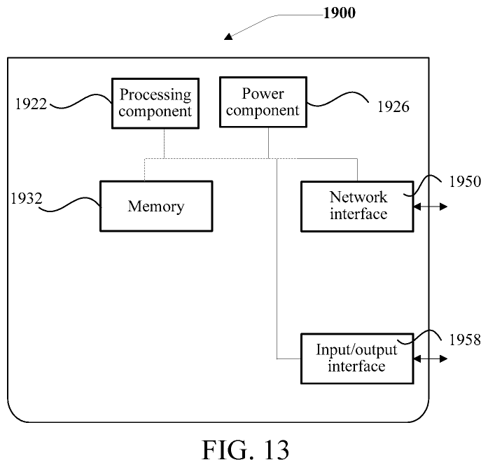

FIG. 13 is a block diagram illustrating another electronic device according to embodiments of the present disclosure. For example, the electronic device 1900 may be provided as a server. Referring to FIG. 13, the electronic device 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. Further, the processing component 1922 may be configured to execute instructions so as to execute the above methods.

The electronic device 1900 may further include a power component 1926 configured to execute power management of the electronic device 1900, a wired or wireless network interface 1950 configured to connect the electronic device 1900 to the network, and an I/O interface 1958. The electronic device 1900 may be operated based on an operating system stored in the memory 1932, such as Windows Server™, Mac OS X™, Unix™, Linux™, FreeBSD™ or the like.

In an exemplary embodiment, a non-volatile computer-readable storage medium is further provided, for example, a memory 1932 including computer program instructions, which can executed by the processing component 1922 of the electronic device 1900 to implement the methods above.

The present disclosure may be a system, a method, and/or a computer program product. The computer program product may include a computer-readable storage medium having computer-readable program instructions thereon for causing a processor to carry out aspects of the present disclosure.

The computer-readable storage medium may be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination thereof More specific examples (a non-exhaustive list) of the computer-readable storage medium include: a portable computer diskette, a hard disk, a Random Access Memory (RAM), an ROM, an EPROM (or a flash memory), a SRAM, a portable Compact Disk Read-Only Memory (CD-ROM), a Digital Versatile Disc (DVD), a memory stick, a floppy disk, a mechanically encoded device such as punch-cards or raised structure in a groove having instructions stored thereon, and any suitable combination thereof. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a Local Area Network (LAN), a wide area network and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In a scenario involving a remote computer, the remote computer may be connected to the user's computer through any type of network, including a LAN or a Wide Area Network (WAN), or the connection may be made to an external computer (for example, through the Internet using an Internet service provider). In some embodiments, electronic circuitry including, for example, programmable logic circuitry, Field-Programmable Gate Arrays (FGPAs), or Programmable Logic Arrays (PLAs) may execute the computer-readable program instructions by utilizing state information of the computer-readable program instructions to personalize the electronic circuitry, in order to implement the aspects of the present disclosure.

The aspects of the present disclosure are described herein with reference to flowcharts and/or block diagrams of methods, apparatuses (systems), and computer program products according to the embodiments of the present disclosure. It should be understood that each block of the flowcharts and/or block diagrams, and combinations of the blocks in the flowcharts and/or block diagrams can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can cause a computer, a programmable data processing apparatus, and/or other devices to function in a particular manner, such that the computer-readable medium having instructions stored therein includes an article of manufacture instructing instructions which implement the aspects of the functions/acts specified in one or more blocks of the flowcharts and/or block diagrams.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus or other device implement the functions/acts specified in one or more blocks of the flowcharts and/or block diagrams.

The flowcharts and block diagrams in the accompanying drawings illustrate the architecture, functionality and operations of possible implementations of systems, methods, and computer program products according to multiple embodiments of the present disclosure. In this regard, each block in the flowchart of block diagrams may represent a module, segment, or portion of instruction, which includes one or more executable instructions for implementing the specified logical function(s). In some alternative implementations, the functions noted in the block may also occur out of the order noted in the accompanying drawings. For example, two blocks shown in succession may, in fact, be executed substantially concurrently, or the blocks may sometimes be executed in the reverse order, depending upon the functionality involved. It should also be noted that each block of the block diagrams and/or flowcharts, and combinations of blocks in the block diagrams and/or flowcharts, can be implemented by special purpose hardware-based systems that perform the specified functions or acts or carried out by combinations of special purpose hardware and computer instructions.

The descriptions of the embodiments of the present disclosure have been presented for purposes of illustration, but are not intended to be exhaustive or limited to the embodiments disclosed. Many modifications and variations will be apparent to persons of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

1. An image processing method, comprising:
obtaining multiple original images which are collected by a Time of Flight (TOF) sensor in the same exposure process and have a signal-noise rate lower than a first numerical value, wherein phase parameter values corresponding to same pixel points in the multiple original images are different; and
performing optimization processing on the multiple original images by means of a neural network to obtain depth maps corresponding to the multiple original images, wherein the processing comprises at least one convolution processing and at least one nonlinear function mapping processing.

2. The method according to claim 1, wherein performing optimization processing on the multiple original images by means of the neural network to obtain depth maps corresponding to the multiple original images comprises:
performing optimization processing on the multiple original images by means of the neural network, and outputting multiple optimized images of the multiple original images, wherein the signal-noise rate of the optimized image is higher than that of the original image, and performing post-processing on the multiple optimized images to obtain the depth maps corresponding to the multiple original images.

3. The method according to claim 1, wherein performing optimization processing on the multiple original images by means of the neural network to obtain depth maps corresponding to the multiple original images comprises:
performing optimization processing on the multiple original images by means of the neural network, and outputting the depth maps corresponding to the multiple original images.

4. The method according to claim 1, wherein performing optimization processing on the multiple original images by means of the neural network to obtain depth maps corresponding to the multiple original images comprises:
inputting the multiple original images into the neural network for optimization processing, to obtain the depth map corresponding to the multiple original images.

5. The method according to claim 1, further comprising:
performing preprocessing on the multiple original images to obtain the multiple preprocessed original images, the preprocessing comprising at least one of the following operations: image calibration, image correction, linear processing between any two original images, or nonlinear processing between any two original images; and
performing optimization processing on the multiple original images by means of the neural network to obtain depth maps corresponding to the multiple original images comprises:
inputting the multiple preprocessed original images into the neural network for optimization processing, to obtain the depth maps corresponding to the multiple original images.

6. The method according to claim 1, wherein the optimization processing performed by the neural network comprises Q groups of optimization procedures which are performed sequentially, and each group of optimization procedures comprises at least one convolution processing and/or at least one nonlinear mapping processing;
wherein performing optimization processing on the multiple original images by means of the neural network comprises:
using the multiple original images as input information of a first group of optimization procedures, and obtaining a feature optimal matrix for the first group of optimization procedures after the processing of the first group of optimization procedures;
using a feature optimal matrix output in the n-th group of optimization procedures as input information of the (n+1)-th group of optimization procedures for optimization processing, or using feature optimal matrices output in the first n groups of optimization procedures as input information of the (n+1)-th group of optimization procedures for optimization processing, wherein n is an integer greater than 1 and less than Q; and
obtaining an output result based on a feature optimal matrix obtained after the processing of the Q-th group of optimization procedures.

7. The method according to claim 6, wherein the Q groups of optimization procedures comprise down-sampling processing, residual processing, and up-sampling processing which are performed sequentially, and performing optimization processing on the multiple original images by means of the neural network comprises:
performing the down-sampling processing on the multiple original images to obtain first feature matrix fusing feature information of the multiple original images;
performing the residual processing on the first feature matrix to obtain a second feature matrix; and
performing the up-sampling processing on the second feature matrix to obtain a feature optimal matrix, wherein the output result of the neural network is obtained based on the feature optimal matrix.

8. The method according to claim 7, wherein performing the up-sampling processing on the second feature matrix to obtain the feature optimal matrix comprises:
using a feature matrix obtained in the down-sampling processing procedure to perform the up-sampling processing on the second feature matrix to obtain the feature optimal matrix.

9. The method according to claim 1, wherein the neural network is obtained by training a train set, wherein each of multiple training samples comprised in the train set comprises multiple first sample images, multiple second sample images corresponding to the multiple first sample images, and depth maps corresponding to the multiple second sample images, wherein the second sample image and the corresponding first sample image are images for the same object, and the signal-noise rate of the second sample image is higher than that of the first sample image;
wherein the neural network is a generative network in a generative adversarial network obtained by training;
a network loss value of the neural network is a weighted sum of a first network loss and a second network loss, wherein
the first network loss is obtained based on differences between multiple predicted optimization images obtained by processing the multiple first sample images comprised in the training sample by means of the neural network and the multiple second sample images comprised in the training sample, and
the second network loss is obtained based on differences between predicted depth maps obtained by post-processing the multiple predicted optimization images and depth maps comprised in the training sample.

10. An image processing apparatus, comprising:
a processor; and
a memory having stored thereon instructions that, when executed by the processor, cause the processor to:
obtain multiple original images which are collected by a Time of Flight (TOF) sensor in the same exposure process and have a signal-noise rate lower than a first numerical value, wherein phase parameter values corresponding to same pixel points in the multiple original images are different; and
perform optimization processing on the multiple original images by means of a neural network to obtain depth maps corresponding to the multiple original images, wherein the processing comprises at least one convolution processing and at least one nonlinear function mapping processing.

11. The apparatus according to claim 10, wherein performing optimization processing on the multiple original images by means of the neural network to obtain depth maps corresponding to the multiple original images comprises:
performing optimization processing on the multiple original images by means of the neural network, and outputting multiple optimized images of the multiple original images, wherein the signal-noise rate of the optimized image is higher than that of the original image; and
performing post-processing on the multiple optimized images to obtain the depth maps corresponding to the multiple original images.

12. The apparatus according to claim 10, wherein performing optimization processing on the multiple original images by means of the neural network to obtain depth maps corresponding to the multiple original images comprises:
performing optimization processing on the multiple original images by means of the neural network, and outputting the depth maps corresponding to the multiple original images.

13. The method according to claim 10, wherein performing optimization processing on the multiple original images by means of the neural network to obtain depth maps corresponding to the multiple original images comprises:
inputting the multiple original images into the neural network for optimization processing, to obtain the depth maps corresponding to the multiple original images.

14. The apparatus according to claim 10, the processor is further configured to:
perform preprocessing on the multiple original images to obtain the multiple preprocessed original images, the preprocessing comprising at least one of the following operations: image calibration, image correction, linear processing between any two original images, or nonlinear processing between any two original images; and
performing optimization processing on the multiple original images by means of the neural network to obtain depth maps corresponding to the multiple original images comprises:
inputting the multiple preprocessed original images into the neural network for optimization processing, to obtain the depth maps corresponding to the multiple original images.

15. The apparatus according to claim 10, wherein the optimization processing performed by the neural network comprises Q groups of optimization procedures which are performed sequentially, and each group of optimization procedures comprises at least one convolution processing and/or at least one nonlinear mapping processing;
wherein performing optimization processing on the multiple original images by means of the neural network comprises:
using the multiple original images as input information of a first group of optimization procedures, and obtaining a feature optimal matrix for the first group of optimization procedures after the processing of the first group of optimization procedures;
using a feature optimal matrix output in the n-th group of optimization procedures as input information of the (n+1)-th group of optimization procedures for optimization processing, or using feature optimal matrices output in the first n groups of optimization procedures as input information of the (n+1)-th group of optimization procedures for optimization processing, wherein n is an integer greater than 1 and less than Q; and
obtaining an output result based on a feature optimal matrix obtained after the processing of the Q-th group of optimization procedures.

16. The apparatus according to claim 15, wherein the Q groups of optimization procedures comprise down-sampling processing, residual processing, and up-sampling processing which are performed sequentially, and performing optimization processing on the multiple original images by means of the neural network comprises:
performing the down-sampling processing on the multiple original images to obtain first feature matrix fusing feature information of the multiple original images;
performing the residual processing on the first feature matrix to obtain a second feature matrix; and
performing the up-sampling processing on the second feature matrix to obtain a feature optimal matrix, wherein the output result of the neural network is obtained based on the feature optimal matrix.

17. The apparatus according to claim 16, wherein performing the up-sampling processing on the second feature matrix to obtain the feature optimal matrix comprises:
using a feature matrix obtained in the down-sampling processing procedure to perform the up-sampling processing on the second feature matrix to obtain the feature optimal matrix.

18. The apparatus according to claim 10, wherein the neural network is obtained by training a train set, wherein each of multiple training samples comprised in the train set comprises multiple first sample images, multiple second sample images corresponding to the multiple first sample images, and depth maps corresponding to the multiple second sample images, wherein the second sample image and the corresponding first sample image are images for the same object, and the signal-noise rate of the second sample image is higher than that of the first sample image;
wherein the neural network is a generative network in a generative adversarial network obtained by training;
a network loss value of the neural network is a weighted sum of a first network loss and a second network loss, wherein
the first network loss is obtained based on differences between multiple predicted optimization images obtained by processing the multiple first sample images comprised in the training sample by means of the neural network and the multiple second sample images comprised in the training sample, and
the second network loss is obtained based on differences between predicted depth maps obtained by post-processing the multiple predicted optimization images and depth maps comprised in the training sample.

19. A non-transitory computer-readable storage medium, having computer program instructions stored thereon, wherein when the computer program instructions are executed by a processor, the processor is caused to perform the operations of:
obtaining multiple original images which are collected by a Time of Flight (TOF) sensor in the same exposure process and have a signal-noise rate lower than a first numerical value, wherein phase parameter values corresponding to same pixel points in the multiple original images are different; and
performing optimization processing on the multiple original images by means of a neural network to obtain depth maps corresponding to the multiple original images, wherein the processing comprises at least one convolution processing and at least one nonlinear function mapping processing.
